(19) United States
(12) Patent Application Publication
(10) Pub. No.: US 2026/0127569 A1
(43) Pub. Date: May 7, 2026

(54) SYSTEM AND METHOD FOR PROCESSING A GROUP PAYMENT TRANSACTION USING COMPUTER VISION AND BIOMETRIC INFORMATION

(71) Applicant: MASTERCARD INTERNATIONAL INCORPORATED, Purchase, NY (US)

(72) Inventors: Christopher T. Scholl, Manchester, MO (US); David Vorhies, Saint Charles, MO (US); Shawn Mehrhoff, Saint Ann, MO (US)

(21) Appl. No.: 18/938,105

(22) Filed: Nov. 5, 2024

(51) Int. Cl. G06Q 20/22; G06Q 20/32; G06Q 50/12

(52) U.S. Cl. CPC G06Q 20/22; G06Q 20/322; G06Q 50/12

(57) ABSTRACT

A group payment computing system that: receives a group transaction image associated with a transaction including one or more members of a group for purposes of dividing, amongst the one or more members, a transaction amount associated with the transaction made by the group at a merchant; analyzes the group transaction image using computer vision tools to determine an identity of the one or more members; determines an amount of the transaction attributable to each of the one or more members based upon input from the one or more members of the group; causes a payment submission option to be displayed on a user device associated with the one or more members; and in response to the payment submission option being selected, initiates a plurality of payment transactions, each payment transaction being between one of the one or more members and the merchant for the attributable amount.

### BACKGROUND

This disclosure relates to electronic payment transactions, and, more particularly, to processing group payment transactions using multiple accounts, computer vison, and biometric information.

Groups of consumers are often presented with purchasing situations in which each member of the group is required to pay for a portion of a purchase. One very common situation is when a group goes to a restaurant and shares a meal and drinks. In certain instances, the restaurant/merchant may not be able to or willing to generate individual bills for each consumer and, as a result, one consumer generally pays for the meal under the assumption that he or she will be reimbursed by the other members of the group. Settling up between the payee of the group and the other individual group members is generally unreliable and usually involves one or more of a cash exchange, later settlement through electronic payment transfers, or a later promise that the group member will pay back the payee in kind. These issues are further exacerbated when the group members are not in close proximity. For example, if a group of friends dispersed across the country wish to split a gift purchase for another friend, they must generally rely on one of them to make the purchase on behalf of the group on the promise of later reimbursement.

The ubiquity of multi-account purchasing situations renders known systems in which a consumer or group of consumers are limited to paying using a single payment card account undesirable. Today, making group payments is cumbersome, and takes time to track payments down from individuals. For example, such known systems are inconvenient and lead to consumer dissatisfaction because consumers are unable to pay for a purchase as they wish. Transaction time may also be increased as consumers try to negotiate or otherwise determine how to fund the purchase and ensure that the payee is adequately reimbursed. In some cases, consumers are unable to see if their friends/fellow patrons have selected their items and/or paid for their portion of the bill, and items may be missed, which can be problematic if a person of the party has left early. Additionally, when using a group digital payment scheme, each member of the group typically has to use their own device (e.g., mobile phone) to initiate their contribution to cover their portion of the bill, which is inefficient.

In light of the foregoing, a system and method for facilitating a streamlined group payment transaction is needed that resolves the inefficiencies and inconvenience of known single payment account systems.

### BRIEF DESCRIPTION OF THE DISCLOSURE

In one aspect, a group payment computing system including a group payment computing device including one or more processors in communication with one or more memory devices, the one or more processors programmed to: (a) receive a group transaction image associated with a transaction including one or more members of a group for purposes of dividing, amongst the one or more members of the group, a transaction amount associated with the transaction made by the group at a merchant, the group transaction image being a photographic image showing a portion of the one or more members of the group; (b) analyze the group transaction image using computer vision tools to determine an identity of the one or more members of the group associated with the transaction; (c) determine an amount of the transaction attributable to each of the one or more members of the group associated with the transaction based upon input from the one or more members of the group; (d) cause a payment submission option to be displayed on a user device associated with the one or more members of the group, the payment submission option corresponding to the amount of the transaction attributable to each of the one or more members of the group associated with the transaction; and (e) in response to the payment submission option being selected, initiate a plurality of payment transactions, each payment transaction being between one of the one or more members of the group and the merchant for the attributable amount for the respective member of the one or more members of the group.

In another aspect, a computer-implemented method for providing a group payment computing system using at least one processor in communication with at least one memory, the method including: (a) receiving a group transaction image associated with a transaction including one or more members of a group for purposes of dividing, amongst the one or more members of the group, a transaction amount associated with the transaction made by the group at a merchant, the group transaction image being a photographic image showing a portion of the one or more members of the group; (b) analyzing the group transaction image using computer vision tools to determine an identity of the one or more members of the group associated with the transaction; (c) determining an amount of the transaction attributable to each of the one or more members of the group associated with the transaction based upon input from the one or more members of the group; (d) causing a payment submission option to be displayed on a user device associated with the one or more members of the group, the payment submission option corresponding to the amount of the transaction attributable to each of the one or more members of the group associated with the transaction; and (e) in response to the payment submission option being selected, initiating a plurality of payment transactions, each payment transaction being between one of the one or more members of the group and the merchant for the attributable amount for the respective member of the one or more members of the group.

In another aspect, one or more non-transitory computer-readable storage media with instructions stored thereon that, in response to being executed, cause a group payment computing system to: (a) receive a group transaction image associated with a transaction including one or more members of a group for purposes of dividing, amongst the one or more members of the group, a transaction amount associated with the transaction made by the group at a merchant, the group transaction image being a photographic image showing a portion of the one or more members of the group; (b) analyze the group transaction image using computer vision tools to determine an identity of the one or more members of the group associated with the transaction; (c) determine an amount of the transaction attributable to each of the one or more members of the group associated with the transaction based upon input from the one or more members of the group; (d) cause a payment submission option to be displayed on a user device associated with the one or more members of the group, the payment submission option corresponding to the amount of the transaction attributable to each of the one or more members of the group associated with the transaction; and (e) in response to the payment submission option being selected, initiate a plurality of payment transactions, each payment transaction being between one of the one or more members of the group and the merchant for the attributable amount for the respective member of the one or more members of the group.

### BRIEF DESCRIPTION OF THE DRAWINGS

FIG. 1 is a schematic diagram illustrating an example multi-party payment processing system for enabling payment transactions used in conjunction with a group payment transaction (GPT) system in accordance with one embodiment of the present disclosure.

FIG. 2 is a schematic diagram illustrating a group payment transaction (GPT) system for performing group payment transaction card transactions according to one embodiment of the present disclosure.

FIG. 3 is a schematic illustration of computing and server devices for use in the GPT computing systems of FIGS. 1 and 2, according to one embodiment of the present disclosure.

FIG. 4 is a schematic illustration of a user personal electronic device for use in connection with the GPT computing systems of FIGS. 1 and 2, according to one embodiment of the present disclosure.

FIG. 5A is a diagram illustrating a registration process for registering a user for a GPT service associated with the GPT computing systems of FIGS. 1 and 2, according to one embodiment of the present disclosure.

FIG. 5B is a diagram illustrating generation of a user identification profile for use with the GPT service, according to one embodiment of the present disclosure.

FIG. 6 is a diagram illustrating an example data flow for processing a group payment transaction, according to one embodiment of the present disclosure.

FIG. 7 is a diagram illustrating example object detection of items and biometric detection of people in a photograph, according to one embodiment of the present disclosure.

FIG. 8 is a diagram illustrating an example data flow for integrating the GPT computing system with merchant management software, according to one embodiment of the present disclosure.

FIG. 9 is a diagram illustrating additional example object detection of items and biometric detection of people in a photograph, according to one embodiment of the present disclosure.

FIG. 10 is an example user interface of a GPT service for processing a group transaction in accordance with FIG. 9, according to one embodiment of the present disclosure.

FIG. 11 is another example user interface of the GPT service for processing a group transaction in accordance with FIG. 9, according to one embodiment of the present disclosure.

FIG. 12 is an example machine learning model scheme, according to one embodiment of the present disclosure.

FIG. 13 is an example configuration of the GPT computing system, according to one embodiment of the present disclosure.

FIG. 14 is an example configuration of a server and/or client computing device, according to one embodiment of the present disclosure.

FIG. 15 is an example configuration of a user personal electronic device, according to one embodiment of the present disclosure.

FIG. 16 illustrates a process flow for an example biometric detection method used for processing a group member payment for a group transaction, according to one embodiment of the present disclosure.

FIG. 17 illustrates a process flow for an example object detection method use for processing a group member payment for a group transaction, according to one embodiment of the present disclosure.

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The systems and methods disclosed herein provide for a group payment transaction (GPT) computing system and GPT service (also referred to herein as a GPT processing system) that use computer vision tools and machine learning techniques to analyze photographs to detect and identify members of a group present at a common event. In doing so, each member's attendance at the event can be confirmed, and also payment can be collected from each group member, via a single photograph, when a group purchase such as for a meal was made. Each member uploads a (e.g., profile) picture to link their picture and the contact information on their personal electronic device to the GPT service. The GPT service may also be referred to herein as a GPT processing system. An identity check is performed with each individual's photograph and matched with various digital ID checks, such as via a government database. Further, geo-location (e.g., geo-proximity amongst the members of the group) is leveraged to confirm the location of the members having a verified ID (e.g., government ID) and their proximity to other members of the group, in particular at a common location such as a restaurant or other merchant. With each contact listed in the members' mobile phones, the contact picture link to respective member as well as their other information such as their mobile phone number. When a photograph is taken, an associated computer vision function will identify and link back to the phone contact information, sending a payment link for an amount to be paid by each person in the photograph. A push is sent to each registered member via their associated phone number, email, or mobile app. A default setting may prompt each person to pay equal portion of the bill due. However, members of the group may opt-in to only pay for their own items, or for items of another.

As described herein, the GPT computing system enables group payment by facilitating the necessary exchange of transaction data between parties of the transaction. More specifically, a GPT computing system enables merchants and acquiring banks to pull funds from each member of the group to settle the total amount due. The GPT computing system further ensures that authorization, settlement, clearance, and any associated processing of the transaction is conducted such that each individual payment account used in the transaction is properly authorized and charged for its respective amount of the GPT transaction. For example, a group payment transaction by individuals A, B, and C for $60 divided evenly between A, B, and C requires that the payment accounts of each of A, B, and C be authorized and charged for $20.

In the example embodiments, the GPT computing system receives and processes biometric information of the group members, and may also receive and process object identification information, such as items purchased by the group as part of the transaction. Once the members agree on how to split the bill and initiate payment via the payment link of the GPT service, various transaction request messages corresponding to the transaction (with each transaction request message including an identifier corresponding to a payment card account and an amount to be charged to the payment card account) are sent within the payment network. The merchant is then paid in full via the various amounts paid by the members of the group.

The GPT computing system generally coordinates the authorization, clearing, and settlement process for a given transaction. More specifically, the GPT computing system facilitates authorization, clearing, and settlement (each of which is discussed in more detail below) for each sub-transaction of an individual member of the group relative to the overall group transaction.

Additionally, or alternatively, a user of the GPT service may set up a (motion mechanism such as a gesture) for payment (e.g., such as a blink, smile, wink, etc.) and in a live photograph mode, such gesture is captured and an automatic withdraw of the owed amount is divided equally across the members appearing the photograph. Motion mechanism (e.g., gesture) from a mobile phone can be prompted by a quick flash pulse or, if in a front-facing camera photograph mode, a graphic indicting payment requested.

A technical effect of the systems and methods described herein is achieved by performing at least one of the following steps: (a) leverage computer vision tools and machine learning to identify people and objects to streamline group payments; (b) present dynamic payment options within a confined display area of a mobile electronic device via a particularized graphic user interface; (c) improve automatic payments via improved authentication, including combining a plurality of authentication factors such as geo-location, government identification, and personal contact data to assist in authenticating a user; (d) conserve significant amounts of human and computational resources; (e) improve speed in the analysis of and processing of group payments; (f) reduce processing required for determining user identities; (g) ability to analyze a wide variety of parameters and dimensions in connection with credit card payments; and (h) improve the customization of group payments (increased user flexibility in splitting a bill via technology). More generally, a technical effect of the systems and methods described herein is improvements in leveraging technology such as computer vision tools and mobile phone capabilities including GPS to improve the speed, customization, and uniformity of group transactions. The methods and systems described herein may be implemented using computer programming or engineering techniques including computer software, firmware, hardware, or any combination or subset thereof.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers, without limitation. Each type of transactions card can be used as a method of payment for performing a transaction.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, artificial intelligence includes computer vision (also referred to as CV) and “machine learning” (also referred to as ML). CV refers to computers and systems configured to interpret and analyze visual data and derive meaningful information from digital images, videos, and other visual inputs. This may include: object detection; object identification; visual content (images, documents, videos) processing; understanding and analysis; item/product search; image classification and search; and/or content moderation. For example, a CV software module may analyze and detect objects in a photograph taken via a mobile phone. ML refers to statistical techniques to give computer systems the ability to “learn” (e.g., progressively improve performance on a specific task) with data, without being explicitly programmed for that specific task. The terms “neural network” (NN), “convolutional neural network” (CNN), and “artificial neural network” (ANN), used interchangeably herein, refer to a type of machine learning in which a network of nodes and edges is constructed that can be used to predict a set of outputs given a set of inputs. This may include ML software module associated with a multimodal ML model that is capable of understanding virtually any input, combining different types of information, and generating almost any output. This may include inputs such as photographs taken via a mobile phone, for example. CV techniques may be used in conjunction with ML techniques and vice versa. For example, a CV module may be integrated with an ML module to realize a joint CV/ML module that may be associated with one or more ML models (e.g., ML models for assisting with CV aspects such as object detection (where objects may include physical objects such as purchased items, as well as biometric “objects” such as faces, hands, and the like), and ML models for assisting. CV techniques may include histogram of oriented gradients, region-based CNN (R-CNN, including Fast/Faster R-CNN), single shot detector (SSD), and YOLO (You Only Look Once), and may utilize object detection libraries. The CV software module may include an associated model which is initially calibrated in part on such object detection libraries, then re-trained over time with inputs such as photographs to improve object detection, such as photographs taken using a mobile camera or camera of a similar electronic device. Pre-trained and deep learning models may be used.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of AT&T located in New York, New York). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

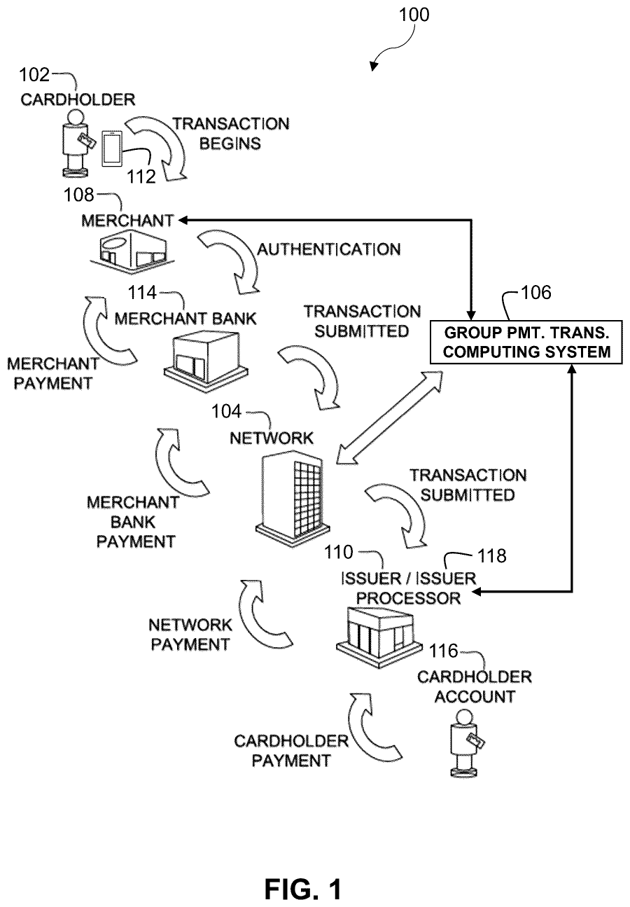

FIG. 1 illustrates a schematic diagram of an example multi-party payment account system 100 for enabling payment transactions initiated by one or more cardholders 102 (e.g., purchasers 102) over a payment processing network 104 that is in communication and used in conjunction with a GPT computing system 106. As described below in more detail, GPT computing system 106 is configured to collect data from cardholders 102 for processing one or more group transactions made by the cardholders 102 at a merchant 108. Embodiments described herein may relate to a transaction card system, such as a payment card payment system using the Mastercard interchange network and/or third party payment processing systems and networks. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.). In the exemplary embodiment, GPT computing system 106 is communicatively coupled to merchant 108, processing network 104, and an issuer 110 (e.g., issuer bank). As used herein, merchant 108 and issuer 110 may be directly coupled to GPT computing system 106, or may be indirectly coupled to GPT computing system 106 through payment processing network 104.

In the example embodiment, a financial institution called the “issuer” or “issuing bank” issues an account, such as a credit card account, a debit account, or a prepaid card account to a cardholder 102, who uses the account to tender payment for a purchase from a merchant 108. In one embodiment, cardholder 102 presents a payment card and/or a digital wallet to merchant 108 using a user computing device (also known as card-present transactions). In another embodiment, the user does not present a physical payment device, and instead performs a card-not-present transaction. For example, the card-not-present transaction may be initiated via a digital wallet application, through a website or web portal, via telephone, or any other method that does not require the user to present a physical payment card to merchant 108 (e.g., via swiping or inserting the payment card and/or scanning the digital wallet).

To accept payment with the transaction card, merchant 108 establishes an account with a financial institution that is part of the financial payment system. This financial institution is usually called the “merchant bank,” the “acquiring bank,” or the “acquirer.” In one embodiment, cardholder 102 tenders payment for a purchase using a transaction card at a transaction processing device 112 (e.g., transaction device 112, e.g., a point of sale device in an in-store context, or a mobile computing device (e.g., mobile phone) or desktop/laptop computer in an at-home (e.g., online shopping) context), then merchant 108 requests authorization from a merchant bank 114 for the amount of the purchase. The request is usually performed through the use of a point-of-sale terminal, which reads account information of cardholder 102 from a magnetic stripe, a chip, barcode, or embossed characters on the transaction card (e.g., a debit card or a prepaid card) and communicates electronically with the transaction processing computers of a merchant bank 114. Alternatively, merchant bank 114 may authorize a third party to perform transaction processing on its behalf. In this case, the point-of-sale terminal will be configured to communicate with the third party. Such a third party is usually called a “merchant processor,” an “acquiring processor,” or a “third party processor.”

In the example embodiment, merchant 108 communicates with, either directly or indirectly via processing network 104, other systems within multi-party payment account system 100 to authenticate cardholder 102 before the transaction is further processed or to assist an authentication device that is part of the multi-party payment account system shown in FIG. 1 in authenticating cardholder 102. For example, the same entity that provides GPT computing system 106 may provide systems that can authenticate cardholder 102 as described herein. Once cardholder 102 has been authenticated, using processing network 104, computers of merchant bank 114 or merchant processor will communicate with computers of an issuer bank 110 to determine whether an account 116 of cardholder 102 is in good standing and whether the purchase is covered by an available credit line of cardholder 102. Based on these determinations, the request for authorization will be declined or accepted. If the request is accepted, an authorization code (e.g., included in an authorization message) is issued to merchant 108. An authorization message includes a transaction identifier associated with the transaction and an indicator indicating that the transaction was authorized. If the request is not accepted, authorization message includes a transaction identifier associated with the transaction and an indicator indicating that the transaction was declined. In the example embodiment, authorization message is formatted according to ISO 8583 network messaging protocol or the equivalent messaging protocol used by the payment card processing network.

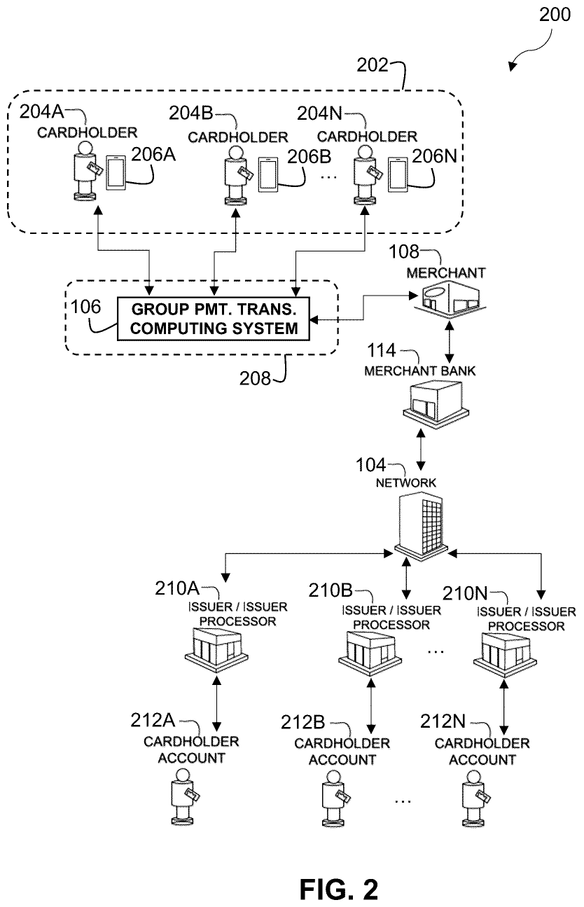

When a request for authorization is accepted, the available credit line of account 116 of cardholder 102 is decreased. Normally, a charge for a payment card transaction is not posted immediately to account 116 of cardholder 102 because certain rules do not allow merchant 108 to charge, or “capture,” a transaction until goods are shipped or services are delivered. However, with respect to at least some debit card transactions, a charge may be posted at the time of the transaction. When merchant 108 ships or delivers the goods or services, merchant 108 captures the transaction by, for example, appropriate data entry procedures on the point-of-sale terminal. This may include bundling of approved transactions daily for standard retail purchases. If cardholder 102 cancels a transaction before it is captured, a “void” is generated. If cardholder 102 returns goods after the transaction has been captured, a “credit” is generated. Processing network 104 and/or issuer bank 110 stores the transaction card information, such as a type of merchant, amount of purchase, date of purchase, etc. in a database (e.g., database 312, shown in FIG. 2).

After a purchase has been made, a clearing process occurs to transfer additional transaction data related to the purchase among the parties to the transaction, such as merchant bank 114, processing network 104, and issuer bank 110. More specifically, during and/or after the clearing process, additional data included in a clearing message, such as a time of purchase, a merchant name, a type of merchant, purchase information, user account information, a type of transaction, a transaction identifier, information regarding the purchased item(s) (e.g., product identifiers), information regarding container(s) of the purchased item(s) (e.g., container identifiers), and/or other suitable information, is associated with a transaction and transmitted between parties to the transaction as transaction data, and may be stored by any of the parties to the transaction. In the example embodiment, the clearing message is formatted according to ISO 8583 network messaging protocol or the equivalent messaging protocol used by the payment card processing network.

After a transaction is authorized and cleared, the transaction is settled among merchant 108, merchant bank 114, and issuer bank 110. Settlement refers to the transfer of financial data or funds among account of merchant 108, merchant bank 114, and issuer bank 110 related to the transaction. Usually, transactions are captured and accumulated into a “batch,” which is settled as a group. More specifically, a transaction is typically settled between issuer bank 110 and processing network 104, and then between processing network 104 and merchant bank 114, and then between merchant bank 114 and merchant 108.

As described above, the various parties to the payment card transaction include one or more of the parties shown in FIG. 1 such as, for example, cardholder 102, merchant 108, merchant bank 114, processing network 104 (also referred to herein as interchange 104 or interchange network 104), issuer bank 110, and/or an issuer processor 118. A transaction may be referred to in a temporal manner, such a historical (e.g., past or prior) transactions, current, or live (e.g., a transaction that may be occurring at any given live moment).

FIG. 2 illustrates a schematic diagram of an example group payment account system 200 for enabling payment transactions initiated by a group 202 including group cardholders 204A, 204B, 204N (where “N” represents unspecified or arbitrary number) over the payment processing network 104 that is in communication and used in conjunction with GPT computing system 106 (each shown in FIG. 1), where group cardholders 204A, 204B, 204N are the same as or similar to cardholders 102 shown in FIG. 1, according to one embodiment of the present disclosure. Each group cardholder 204A, 204B, 204N may have their own respective user device, also referred to herein as a personal electronic device (e.g., “PED”, e.g., a mobile phone, or tablet) 206A, 206B, 206N for use with a GPT service 208 (e.g., GPT processing system 208) provided and operated in conjunction with GPT computing system 106, where each PED 206A to 206N is an embodiment of transaction processing device 112. Each PED 206A to 206N may have stored or accessible thereon an application (or website) capable of interfacing with GPT service 208, which may include a digital wallet storing card information of group cardholders 204A to 204N. GPT service may be configured to have access to such digital wallet of virtual versions of the cards of group cardholders 204A to 204N for processing transaction through GPT computing system 106 and system 200. The cards of group cardholders 204A, 204B, 204N are associated with respective issuer/issuer processor 210A, 210B, 210N, which are in turn associated with respective group cardholder accounts 212A, 212B, 212N, where issuer/issuer processor 210A, 210B, 210N are the same as or similar to issuer 110/issuer processor shown in FIG. 1, and group cardholder accounts 212A, 212B, 212N are the same as or similar to cardholder account 116 shown in FIG. 1. Because group payment account system 200 is a configuration of the baseline multi-party payment account system 100, the operational relationships and payments shown in FIG. 1 and described above in connection with network 104, merchant 108, merchant bank 114, issuer 110, cardholder account 116, and issuer processor 118, are generally the same as described above in connection with FIG. 1, and such baseline information is not repeated here (except for the particular group payment aspects, which may described in more detail).

In an alternative embodiment, PEDs 206A to 206N may not be needed for interaction with GPT service 208 as the merchant 108 may have their own transaction processing device 112 that is configured as a point-of-sale (POS) computing device (also referred to as POS terminal) that has hardware (e.g., camera) and software capable for use with GPT service 208 and GPT computing system 106 and the processing of a group transaction is handled via such a specialized GPT-compatible transaction processing device 112. For example, the GPT-compatible transaction processing device 112 may be configured as a tabletop kiosk used by a restaurant at their tables for processing transactions, except that the tabletop kiosk has the necessary hardware (e.g., camera) and software to utilize GPT service 208 in conjunction with the backend system aspects of GPT computing system 106. Alternatively, tabletop kiosks may not be needed, and there may instead only be a single/central transaction processing device 112, e.g., located at the front of the restaurant, which is used (e.g., by group cardholders 204A to 204N) to pay for their purchase(s). In such embodiments using either a tabletop kiosk or a single/central transaction processing device 112, each group cardholder 204A to 204N would not need to use their own PED (206A to 206N) to process the transaction, as the group 202 would instead use the tabletop kiosk or single/central transaction processing device 112 to pay.

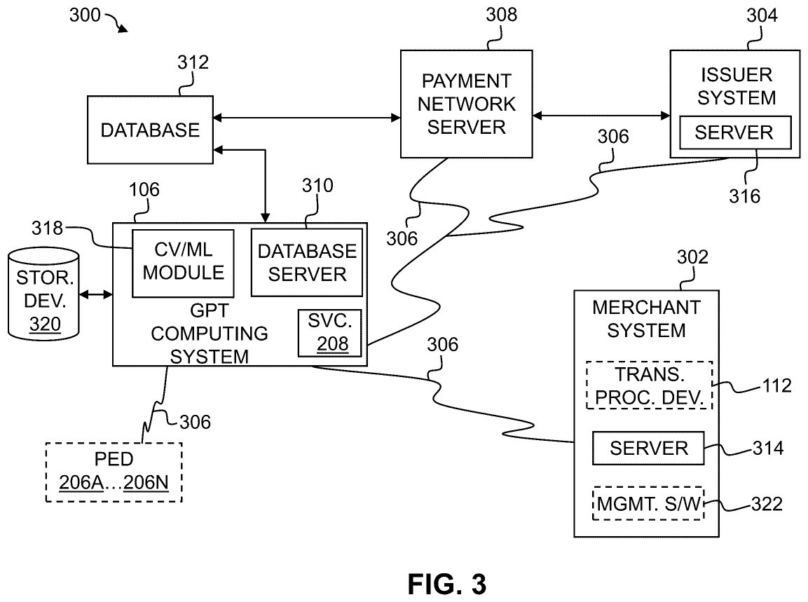

FIG. 3 illustrates a schematic diagram of an example GPT computing platform 300 including GPT computing system 106 (also referred to as GPT computing device 106) and a plurality of client sub-systems coupled to the GPT computing system 106, usable within multi-party payment account system 100 (and as shown in system 200). Client sub-systems may include merchant system 302 (also referred to as merchant computing device 302, or more generally client sub-system 302) and issuer system 304 (also referred to as issuer computing device 304, or more generally client sub-system 304).

Client sub-systems 302 and 304 are coupled to the Internet through many interfaces including a network 306, such as a local area network (LAN) or a wide area network (WAN), dial-in-connections, cable modems, special high-speed Integrated Services Digital Network (ISDN) lines, and RDT networks. Merchant system 302 includes systems associated with merchants 108 (shown in FIG. 1) as well as external systems used to store data. For example, merchant system 302 may include transaction processing device 112 (shown in FIG. 1), which may be realized as a POS terminal communicatively and operatively coupled to an external system of merchants 108. Issuer system 304 includes systems associated with issuer banks 110 (shown in FIG. 1) as well as external systems used to store data. GPT computing system 106 is also in communication with a payment network server 308 associated with interchange network 104 (shown in FIG. 1) using network 306. Further, client sub-systems 302 and 304 may additionally communicate with interchange 104 using network 306. In more general terms, client sub-systems 302 and 304 could be any device capable of interconnecting to the Internet including a web-based (e.g., mobile) phone, PDA, smart devices, or any other web-based connectable equipment such as a POS terminal (e.g., an embodiment of transaction processing device 112 (shown in FIG. 1)).

A database server 310 of GPT computing system 106 is coupled to a database 312, which contains information and data on a variety of matters. For example, database 312 may store cardholder transaction data and issuer/merchant rules regarding transactions. Cardholder transaction data may be processed, sorted, and/or otherwise analyzed according to a list of defined parameters (e.g., transaction type, transaction time, device on which the transaction was initiated, dollar amount of transaction, market segment of merchant and/or item purchased, payment network parameters, and any other applicable parameter relating to ways to categorize such transactions) and rules. In one embodiment, database 312 is a centralized database stored on GPT computing system 106, where access to centralized database 312 may be controlled by rules defined within platform 300 to limit the display of data to authorized client users enrolled with platform 300. In an alternative embodiment, database 312 is stored remotely from GPT computing system 106 and may be non-centralized. Database 312 may be a database configured to store information used by GPT computing system 106 including, for example, historical and current transaction data, prompt data, other user data, merchant data, issuer data, and/or other applicable data. Database 312 may include a single database having separated sections or partitions, or may include multiple databases, each being separate from each other. In some embodiments, database 312 stores transaction data generated over the processing network including data relating to merchants, consumers, account holders, prospective customers, issuers, acquirers, and/or purchases made. Database 312 may include multiple storage units such as hard disks or solid state disks in a redundant array of inexpensive disks (RAID) configuration, and may include a storage area network (SAN) and/or a network attached storage (NAS) system.

Additional components within platform 300 may include a server 314 of merchant system 302, a server 316 of issuer system 304, an artificial intelligence/machine learning (CV/ML) module 318 of GPT computing system 106 (described in more detail herein), and a storage device 320. Server 314 may be configured to provide access to resources, data, services, or programs to other computers of merchants 108 over network 306. Server 316 may be configured to provide access to resources, data, services, or programs to other computers of issuers 110 over network 306. CV/ML module 318 may be configured to assist with providing insight into transactions and/or images used in association with GPT service 208 and GPT computing system 106 by learning transaction and image patterns over time via one or more models and corresponding algorithms (described below in more detail). Storage device 320 may include one or more storage devices used in conjunction with GPT computing system 106, and may store therein both historical (e.g., training) data for training a model of CV/ML module 318, as well as newer transaction data and other data and information used to update group payment algorithms and/or other algorithms of CV/ML module 318, for use in association with the analysis performed by GPT computing system 106. Storage device 320 may also include images provided to or otherwise accumulated by or within GPT computing system 106. In one embodiment, storage device 320 may be integrated with GPT computing system 106. In other embodiments, storage device 320 may be integrated with database 312, or any other storage or database within platform 300.

Merchant system 302 may also include merchant management software 322, which may include a management suite for various aspects of the merchant. For example, in the context of a restaurant, this may include restaurant management software system (e.g., table management software system) that provides features such as reservation management, table assignments, waitlist management, and reporting and analytics. In the context of other types of merchants, merchant management software 322 may be inventory management software for managing stock and sale of items within the merchant's inventory.

The model of CV/ML module 318 may be trained on transaction and/or image data to be able to better recognize and categorize new transactions, determine new or updated payment techniques, and/or assist with other calculations and group payment procedures such as sorting/grouping/partitioning of purchased items, etc. While CV/ML module 318 is shown in FIG. 2 as being integrated within GPT computing system 106, it may also be separate from (but still operatively and communicatively coupled to) GPT computing system 106. PEDs 202A to 202N and transaction processing device 112 are shown in FIG. 3 in dashed lines illustrating how, as described above in connection with FIG. 2, the GPT service 208 may be utilized by either PEDs 202A to 202N or transaction processing device 112.

The machine learning models may use the patterns to detect objects and/or activity in real-time, for example for use in image analysis and processing. A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs. Additionally or alternatively, the machine learning programs may be trained by inputting sample data sets or certain data into the programs, such as transaction data, network messages (e.g., ISO 8583 messages), and/or other internal data regarding transactions. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing - either individually or in combination, for use, for example, in generating outputs for human consumption. The machine learning programs may also include natural language processing, semantic analysis, automatic reasoning, and/or (supervised) machine learning. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

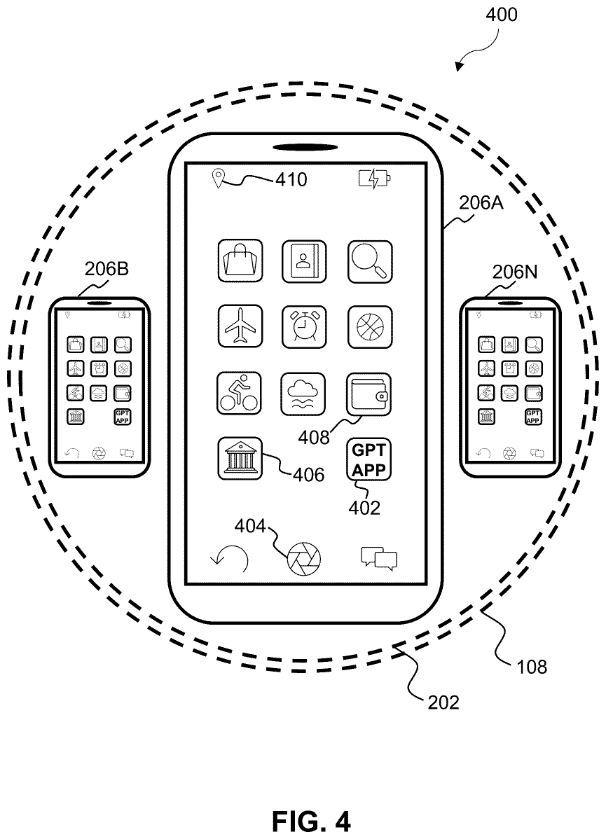

FIG. 4 illustrates an example group payment environment 400 according to one embodiment of the present disclosure. FIG. 4. represents a scenario where group 202 is within a location of a merchant 108 (e.g., inside a merchant 108's physical store location). GPT service 208 may be realized as a standalone GPT application 402 installed on or otherwise available on a PED of a member of group 202 such as PED 206A of cardholder 204A. Alternatively, or additionally, GPT service 208 may be integrated (e.g., as a plugin software component) within an existing application on the PED, such as being implemented within a camera application 404, a banking application 406, and/or a digital payments application 408 (which may be a digital wallet storing one or more virtual (e.g., digital) cards of a cardholder such as cardholder 204A)). For example, GPT service 208 may be provided and operated by the same commercial entity associated with banking application 406 and/or digital payments application 408, and GPT application 402 may not be needed. GPT application 402 (as well as camera application 404, banking application 406, and digital payments application 408) may be configured to access and know a location of PED 206A by virtue of the built-in location mechanism(s) 410 of the PED, wherein location mechanism(s) 410 may include GPS, network (e.g., cellular, Wi-Fi) triangulation, near-field proximity (e.g., Bluetooth, NFC, RFID), and the like. GPT service 208 may utilize the location of the PED by way of location mechanism(s) 410 in association with providing and operating GPT service 208, for example so that GPT service 208 can better determine a location of merchant 108 in which members of group 202 are located, and to determine that members of group 202 are in close proximity to one another (e.g., within the same location of merchant 108, as shown by PEDs 206A, 206B, 206N in FIG. 4). For example, since each member of group 202 is registered with GPT service 208, GPT computing system 106 will have access to each member's PED and be able to geo-locate each member of group 202. GPT service 208 may use location data of the PED for a variety of purposes, including but not limited to geofencing, determining local tax rates, and the like, which may be used in conjunction with CV/ML module 318 which may learn location-based information over time by a cardholder's use of GPT service 208. For example, GPT service 208 may be configured to present various sales promotions such as a coupon of the merchant 108 to group 202 upon group payment (e.g., checkout) using GPT service 208 via a user interface of GPT service 208 presented on a PED of a member of group 202 (described in more detail below).

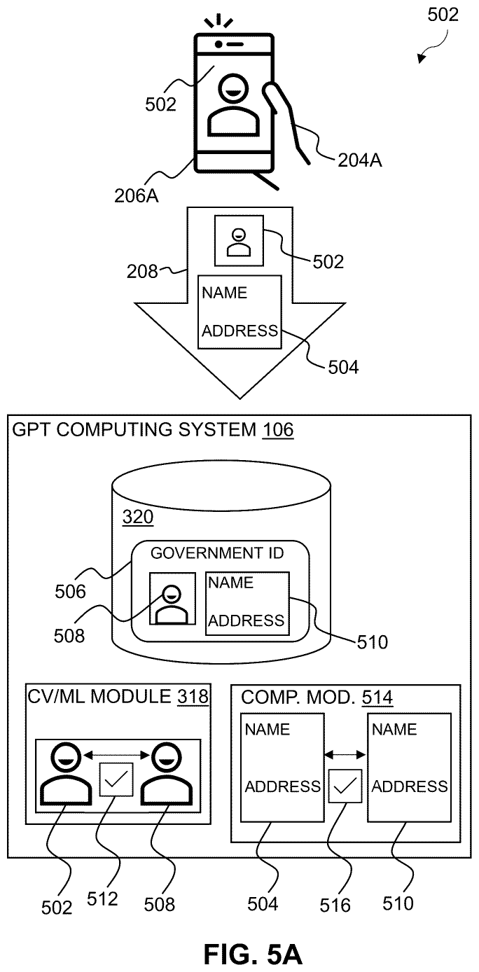

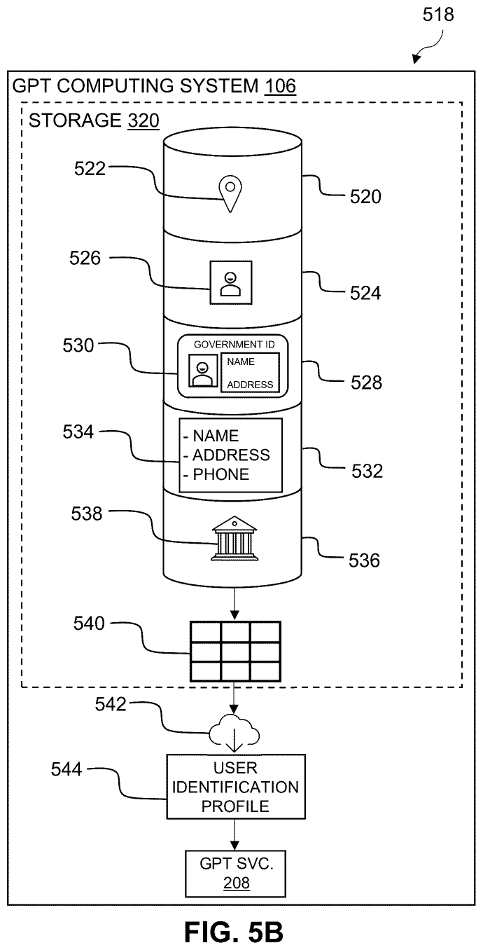

FIG. 5A is a diagram illustrating a registration process flow 500 for registering a user with GPT service 208 according to one embodiment of the present disclosure. For example, geo-location may be leveraged to confirm the location of the person with a government identification (ID) and proximity to other group members (described above in connection with FIG. 4 and location mechanism(s) 410). GPT computing system 106 may also leverage each contact listed in the members' PEDs to further link a photograph to the person and their name, address, and/or phone number (e.g., in the case where the PED is a mobile phone). For example, during registration with GPT service 208, users may be prompted (or required) to grant access to their contacts stored within their PED to GPT service 208. Cardholder 204A takes a photograph 502 (e.g., a self-photograph, or “selfie”) via a camera of PED 206A. Photograph 502 as well as identification information 504 (e.g., name, address, and/or mobile number) is transmitted by way of GPT service 208 to GPT computing system 106. GPT computing system 106 may already have stored therein (e.g., within storage device 320) a copy of a government identification 506 of cardholder 204A (e.g., GPT computing system 106 may pull a copy of the government identification 506 from government records or a data vendor, or users may provide a copy of government identification 506 via a separate registration step of GPT computing system 106). Government identification 506 includes a different photograph 508 of cardholder 204A, as well as government identification (e.g., name and address) information 510. The CV/ML module 318 performs an image comparison on photograph 502 and photograph 508 from government identification 506 to determine a match 512. GPT computing system 106 may also include a comparison module 514 that compares text-based data such name, address, phone number, and the like. Comparison module 514 may be configured to perform any number of comparisons on a variety of information and data types. Text-based data may be stored in a data table within storage device 320, and may be queried and may provide the data in response to such queries. The comparison module 514 performs a text comparison on the identification information 504 and the government identification information 510 to determine a match 516. The text matching may include techniques such as fuzzy logic and/or database-specific functions such as SQL LIKE operator, or other code-based text matching techniques. If a user's biometric and/or other identification information (e.g., name, address) is unable to be match or otherwise verified, the user may be denied registering for GPT service 208. The biometric information and the identification information may, in combination, be referred to as identifying information.

FIG. 5B is a diagram illustrating a process flow 518 for generating a user identification profile for use with GPT service 208 according to one embodiment of the present disclosure. Storage device 320 (shown in FIG. 3) may include a plurality of databases for storing a variety of data including geo-location data, photographs and corresponding photograph data, government identification data, contact information, and financial data which broadly includes information associated with a user's credit cards, past purchases, and the like. Database 520 may include geo-location data 522 such as geo-location 410 (shown in FIG. 4). Database 524 may include photograph data 526, such as photographs 502 and 508 (each shown in FIG. 5, where photograph 508 may be a government ID photograph). Database 528 may include government identification data 528, such as government photograph/name/address data 530, such as photograph 508 and (e.g., name/address) information 510 (each shown in FIG. 5). Database 532 may include contact information such as name/address/mobile phone number/email data 534 (e.g., contact information 534), such as (e.g., government name/address) information 510 (shown in FIG. 5). Database 536 may include various user financial data 538, including credit card information, bank/payment accounts, and the like. The various data of FIG. 5B may be pulled from a variety of sources, including other accounts associated with the user that GPT service was granted access to or can otherwise interface with (e.g., in the case where GPT service 208 is provided and operated by a financial entity that the user already has a relationship with, and that already has verified information about the user accessible within records). The data within databases 520 to 536 may be used to generate one or more tables 540 corresponding to various information, where tables 540 may include a variety of fields for the data, and that may be queried. For example, geo-location data 522 may be stored in a “geo_location” table to store latitude and longitude, which may include fields such as “created-at” (e.g., a timestamp), photograph data 526 may be stored in a “UserPhotos” table, which may include fields such as “profile_photo” (e.g., binary large object (BLOB)), and contact information 534 may be stored in a “Users” table, which may include fields such as “phone_number” (e.g., VARCHAR(20) used for storing a user's phone number). A compilation 542 may be used to generate an overall user identification profile 544, where compilation 542 may include compiling data from the various tables 540 for data collection, data integration, and profile generation, where the user identification profile 544 reflects all applicable data shown in and described in connection within databases 520 to 536 and any other applicable user data, and can be used as part of GPT service 208 for processing of new group payment transactions submitted via GPT service 208, for example to assist with identifying members of the group.

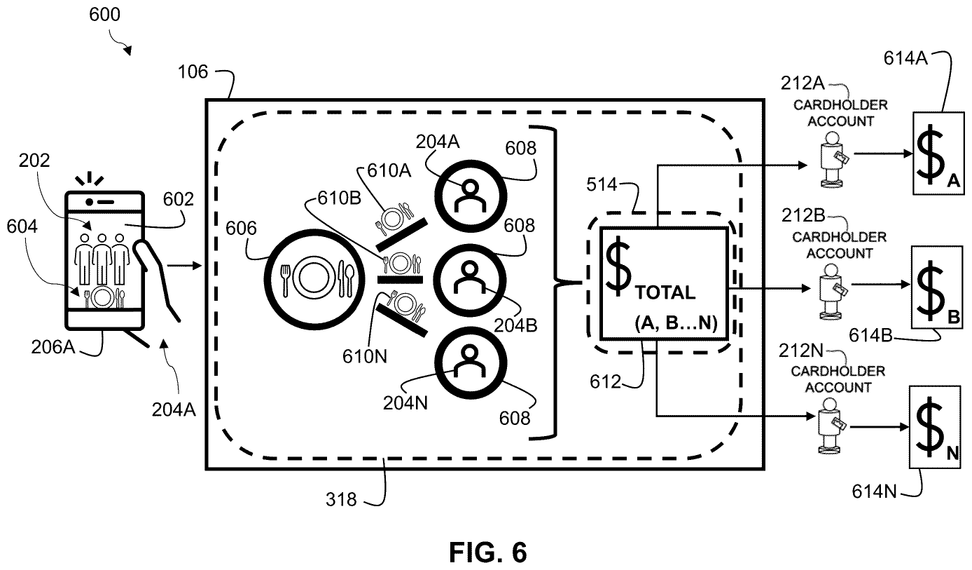

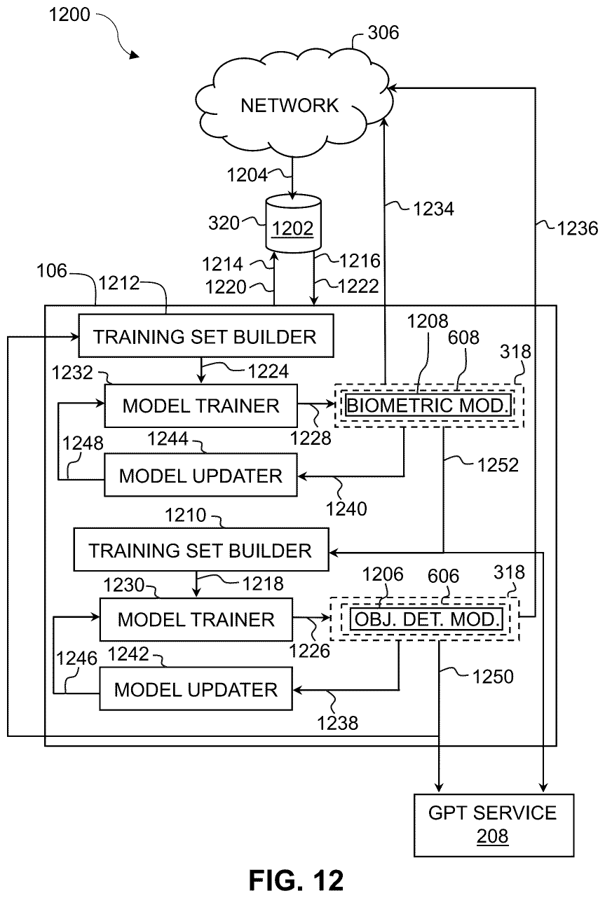

FIG. 6 illustrates an example group payment data flow 600 according to one embodiment of the present disclosure. The embodiment shown in FIG. 6 uses a restaurant as an example of merchant 108. Cardholder 204A, for example, utilizes their PED 206A to take a photograph 602 of group 202 at the restaurant. Photograph 602 includes cardholders 204A to 204N in the image therein, and may also include in the image one or more items 604 purchased by group 202, which may include various food and/or drink items in the context of a restaurant. Photograph 602 is transmitted to GPT computing system 106 as shown, for example, in FIG. 3, so that CV/ML module may process the image, which includes an object detection module 606 and a biometric module 608. Object detection module 606, by way of its associated algorithms and object detection model (shown in FIG. 12), is capable of detecting objects within the image of photograph 602, which, in the restaurant context, may include various food and/or drink items. This may include being able to recognize generic items a pizza or a glass of beer, and/or being able to recognize labels of drinks provided in their original packaging (e.g., a wine bottle label). Object detection module 606 may parse items into parsed item groups 610A, 610B, 610N, which may correlate to items of each cardholder 204A, 204B, 204N, or may correlate items to various other item groupings, such as a food grouping, a drink grouping, and the like. Biometric module 608, by way of its associated algorithms and biometric model (shown in FIG. 12), is capable of detecting biometric features within the image of photograph 602. This may include recognizing facial features of members of group 202, based, for example, on prior images stored within GPT computing system 106 of each member of the group 202, such as images acquired in connection with the registration of each member of group 202 with GPT service 208 (described in more detail below). Facial recognition may evaluate a plurality of datapoints (e.g., distance between eyes and nose, nose and mouth, nose and chin, etc.) in determining a match between a cardholder shown in a photograph submitted via GPT service 208 and a match in a cardholder identification database associated with GPT computing system 106. For example, GPT computing system may have stored therein a biometric template for each registered user, where such template was built from one or more photographs of the registered user. Upon signing up to participate in GPT service 208, each user may be required to submit a photograph in order for GPT computing system 106 to be able to build a biometric template for the user. For example, GPT service 208 may ask a user to submit a self-picture (e.g., “selfie”) picture for registration purposes. Such registration photographs may be authenticated by comparing them against official photographs. For example, GPT service may also ask users to upload a photograph of their driver's license, so that the driver's license image can be compared to the selfie image to authenticate the user. GPT computing system 106 may also obtain photographs of registered users by other means (described in more detail below), which assists in building more robust biometric templates for each registered user, which improves the accuracy and detection of GPT computing system 106.

In one embodiment, GPT computing system 106 may divide the entire (e.g., total) amount 612 (e.g., designated in FIG. 6 as $_{A, B . . . N}) of the transaction by the number of members (e.g., A, B . . . N) in the group, regardless of which member ordered and/or consumed any given item(s). Total amount 612 may be computed by comparison module 514, and/or pulled from and/or compared a total amount stored within merchant management software 322. For example, if group 202 (including cardholders 204A, 204B . . . 204N (where N is a third cardholder such that group 202 includes 3 people)) agrees to simply split the bill evenly, a $99 bill processed by GPT service 208 would cause deduction of cardholder account 212A of cardholder 204A by contribution 614A (e.g., $33 (designated in FIG. 6 as $_{A})), cardholder account 212B of cardholder 204B by contribution 614B (e.g., $33 (designated in FIG. 6 as $_{B})), and cardholder account 212N of cardholder 204N by contribution 614N (e.g., $33 (designated in FIG. 6 as $_{N})).

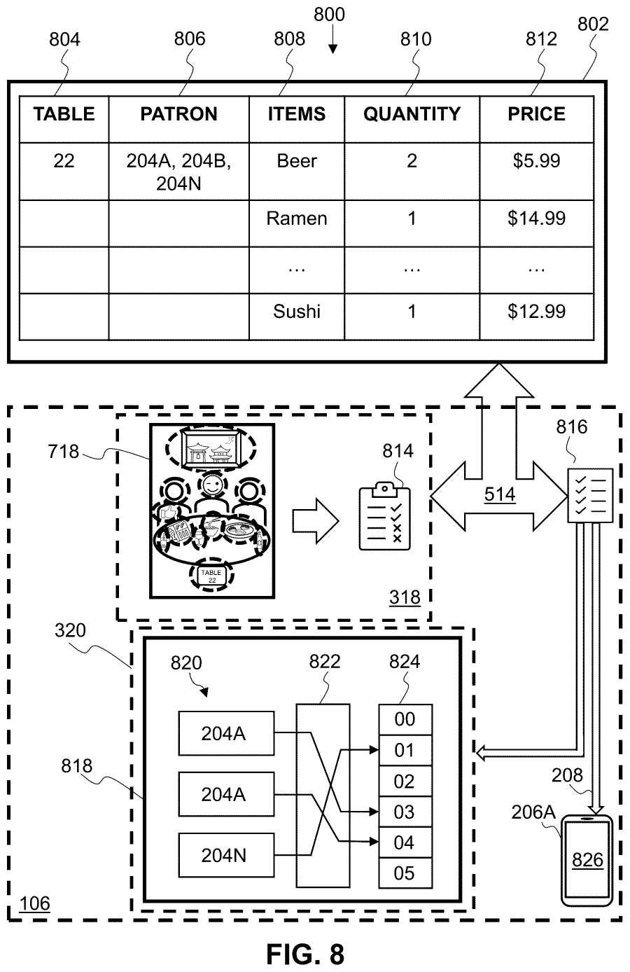

In other embodiments, GPT computing system 106 may take more steps to attribute the exact items ordered/consumed by each member of group 202. This may be done automatically via CV/ML module 318, and/or with assistance from whichever member of group 202 is using GPT service 208 to split the bill associated with the transaction at the merchant 108. For example, CV/ML module 318 may accurately recognize that a pizza was ordered, but then, via a user interface of GPT service 208, prompt a group member to enter into the system how many slices each person of the group consumed. Such a user interface of GPT service 208 is described in more detail below in connection with FIGS. 8-11.

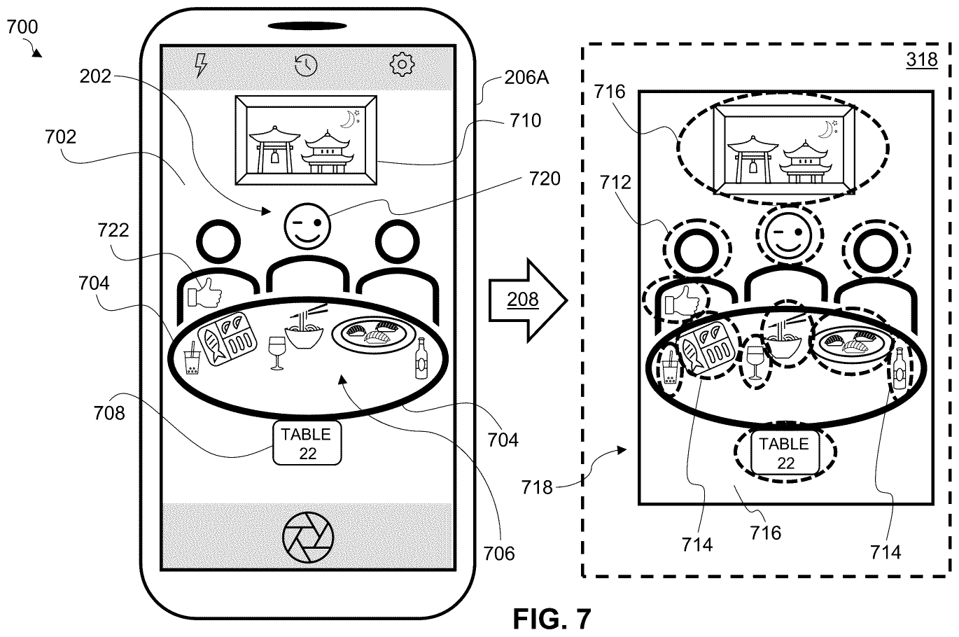

FIG. 7 is a diagram illustrating parsing by CV/ML module 318 of a photograph taken for use with GPT service 208 according to one embodiment of the present disclosure. Cardholder 204A may utilize their PED 206A to take a photograph 702 of group 202 sitting at a table 704 at a restaurant, where a plurality of food and drink items 706 are located on the tabletop. Table 704 may be labeled with signage 708 indicating, for example, a table number (which may be used internally within the restaurant to identify tables, and/or may be loaded into restaurant management software system used by the restaurant to manage tables). Table 704 may be located near a notable object 710 within the restaurant, such as a painting or other decoration. Signage 708 and notable object 710 may be treated as landmarks associated with a particular table. Such landmarks may include unique items on the table (such as signage 708) and/or from background elements (such as notable object 710), and may help CV/ML module in being better able to detect the particular table at which group 202 is seated.

Once the photograph 702 is transmitted via GPT service 208 to GPT computing system 106, the CV/ML module 318 begins to parse the image of photograph 702 to detect people and objects. For example, CV/ML module may parse faces 712, food/drink objects 714, and environmental (e.g., landmark) objects 716. Faces 712 may be parsed by a module the same as or similar to biometric module 608 (shown in FIG. 6 and described above) which may be part of CV/ML module 318, and objects 714 and 716 may be parsed by a module the same as or similar to object detection module 606 (shown in and described in connection with FIG. 6), as illustrated by parsed item groupings 610A, 610B, 610N (shown in and described in connection with FIG. 6). When coupled with the above-described geo-location aspects (e.g., utilizing GPS location of PEDs, utilizing contact information within PEDs), GPT computing system 106 is able to identify a plurality of information, including (i) members of group 202, (ii) specific information about the (e.g., food and drink) items ordered by group 202, and (iii) the particular table group 202 was seated at in a particular restaurant, and generate data reflective of such information for downstream usage (e.g., in splitting the bill amongst members of group 202, as well as training ML models of CV/ML module 318). The image as processed by CV/ML module 318 may be referred to as a processed image 718, and the information derived therefrom may be populated in a data table stored within GPT computing system 106. Members of group 202 may make certain gestures such as a wink 720 and a thumbs up 722 (described in more detail herein).

FIG. 8 illustrates an example integration 800 of GPT computing system 106 with a restaurant management software system 802 in the case of merchant 108 being a restaurant, according to one embodiment of the present disclosure. The CV-based parsing of photographs may be used in a standalone manner or in conjunction with any restaurant management software system may have stored therein the total amount and price of items ordered by the group for any particular table within the restaurant, which may be referenced by GPT computing system 106 as part of its analysis of the image. For example, with or without assistance from merchant management software 322, CV/ML module 318 is configured to parse items from object recognition module 606 into groups 610A, 610B, 610N, which may correspond to each cardholder 204A, 204B, 204N, respectively. Restaurant management software system 802 stores therein restaurant data such as table number 804, patrons 806, types 808 of items ordered, quantities 810 of items ordered, and item prices 812. Restaurant management software system 802 may be integrated as part of merchant management software 322 (shown in FIG. 3), where such software provides features such as reservation management, table assignments, waitlist management, and other reporting and analytics. GPT computing system 106 may be integrated or otherwise be communicatively coupled or interface with merchant management software 322. This enhances the ability of CV/ML module 318 to accurately confirm items detected from the photographs submitted by users to GPT service 208. The data from restaurant management software system 802 may be compared via comparison module 514 with biometric and object detection data 814 extracted and compiled by CV/ML module 318 from a photograph submitted via GPT service 208, such as photograph 718 (e.g., image 718, shown in and described in connection with FIG. 7) to generate a master list 816 of verified table, patron, item, quantity, and price information. The information in master list 816 may be converted into a designated (e.g., secure) format for storage within storage device 320 of GPT computing system 106 via a formatting module 818 of GPT computing system 106. For example, the information in master list 816 may be hashed, where input data (e.g., keys) 820 such as cardholder 204A . . . 204N data (e.g., cardholder names) is input into a hash function 822 to generate a hash function output 824. Hash function 822 is a specialized algorithm that processes the input data 820 and produces a fixed-length hash value, and may be a hash function such as MD5, SHA-1, and SHA-256. Such hashing may improve the security, integrity, and provide efficient/fast recall of data within GPT computing system 106. Additionally, the contents of master list 816 may be exported via GPT service 208 to a user interface 826 (e.g., GUI 826) for viewing by a cardholder (e.g., 204A) on their PED (e.g., 206A), where user interface 826 may be a GUI of GPT APP 402 (shown in and described in connection with FIG. 4).

As shown and described above, GPT computing system 106 may use a variety of data sources and information to confirm the identity of users. This includes, but is not limited to, geo-location information such as shown in and described in connection with FIG. 4 (e.g., wherein the location of each group members PED in close geographical proximity to one another is an indicator that the members of the group are indeed present at the same location). Identity confirmation also includes, but is not limited to, using photographs, names, addresses, phone numbers, email addresses, etc. For example, as shown in and described in connection with FIG. 5A, GPT computing system 106 may also leverage each contact listed in the contact list of a members' PED to further link a photograph to the person and their name, address, and/or phone number (e.g., in the case where the PED is a mobile phone), where photograph 502 as well as identification information 504 (e.g., name, address, and/or mobile number) may be pulled from a user's contacts and leveraged to authenticate users and used in conjunction with the geo-location aspects. Biometric comparisons such as shown in and described in connection with FIGS. 5 and 7 may be performed on any photograph such as photograph 502. While cardholder 204A and PED 206A are shown in FIGS. 5 and 7, this could be any registered user of GPT service 208. Moreover, the combination of the geo-location and biometric tools may even permit a non-registered member of the group to (e.g., indirectly) use GPT service 208. For example, there may be enough identifying information provided by way of known information of the non-registered user and/or by other information of (e.g., registered) members of the group to send a non-registered member a payment link even without the non-registered member having GPT application 402 installed on their PED. In this regard, comparison to government-provided information such as government ID 506 and corresponding photograph 508 and information 510, when combined with the proximity information or other group members, may provide enough capability and certainty to allow a non-registered member of a group to utilize GPT service 208, especially if non-registered member has a credit card issued by the same entity controlling GPT service 208, in which case that entity may already have information of the non-registered member in their systems that can be used for authentication. As such, even if every member in a group photograph is not registered to use GPT service 208, it may be possible for them to use aspects of GPT service 208. Additionally, any new/live photograph taken and used in connection with GPT service 208 may include geo-tagging data therein which can also be leveraged to assist with identification and authentication.

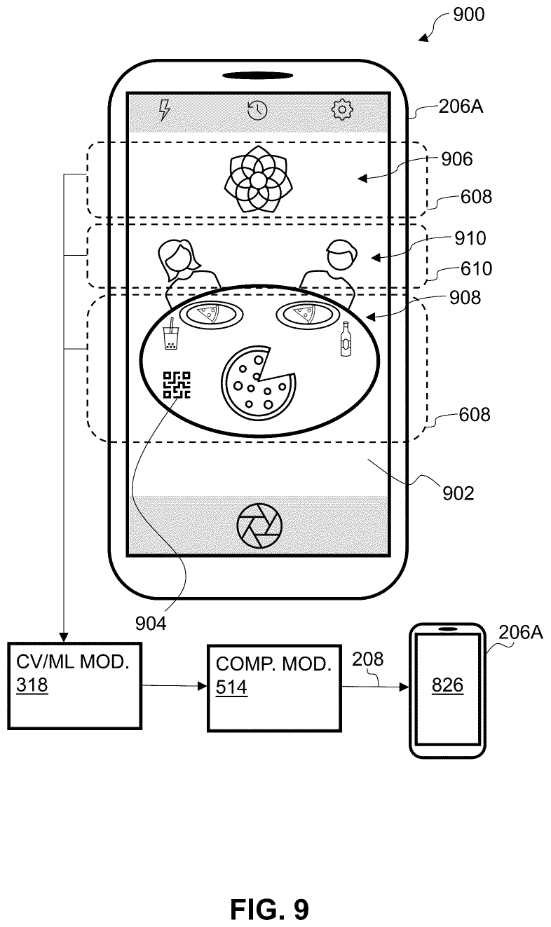

FIGS. 9-11 illustrate additional aspects of GPT computing system, 106 used in connection with a merchant 108 that is a restaurant, including additional aspects of biometric and object detection, and parsing of items to generate a split bill, in accordance with the present disclosure.

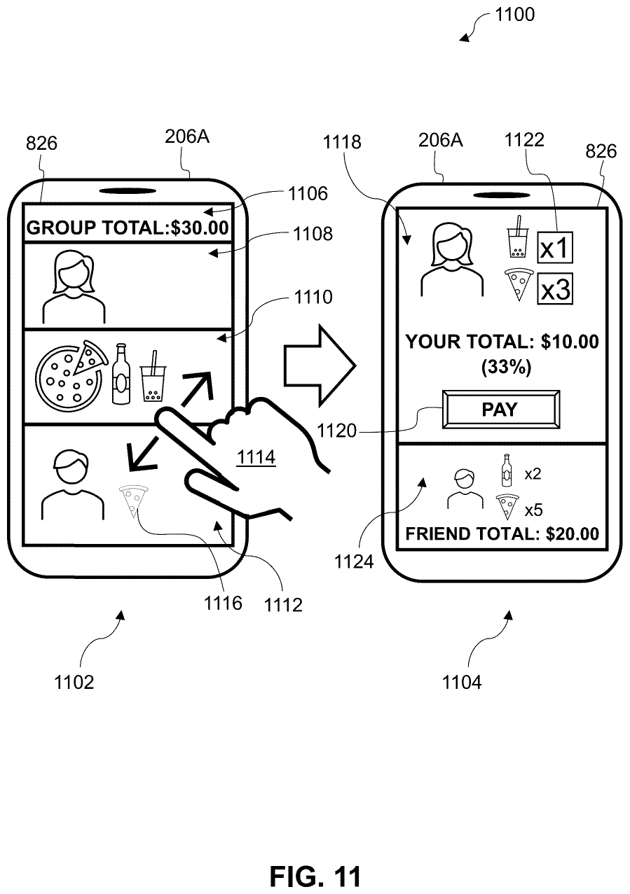

FIG. 9 is a diagram illustrating parsing by CV/ML module 318 of a photograph 902 taken for use with GPT service 208 according to one embodiment of the present disclosure. Cardholder 204A may utilize their PED 206A to take photograph 902 of a group (e.g., 202) sitting at a table at a restaurant, where a plurality of food and drink items are located on the tabletop. The table may be labeled with signage 904 which may be a scannable code such as a QR code that is recognizable by CV/ML module 318 (as compared to signage 708 shown in FIG. 7 which is an actual label of a table number). Signage 904 may provide CV/ML module 318 with additional information to help prepare a master list (e.g., 816) of information for use in the GUI (e.g., 826) of a PED (e.g., 206A). Similar to what is shown in FIGS. 6 and 7, photograph 902 is processed by object detection module 606 and biometric module 608, where object detection module 608 detects objects (e.g., food and drink items and signage 904) in regions 906 and 908 of photograph 902, and biometric module detects faces in region 910. The outputs from object detection module 606 and biometric module 608 are processed in CV/ML module to determine identities of the group members and the type and/or amount of food and drink items. Additionally, group members could take a photograph of their plate after distributing the food. The CV/ML module 318 (e.g., via object detection module 608) will recognize the portion each individual took and split the cost based on amount of food (e.g., one individual takes 4 slices of pizza, while the other two individuals take 2 slices each). The pizza as ordered had a total of 8 slices, meaning that the member that took 4slices will be charged 50% of the cost and the others will each be charged 25% of the cost, which would be shown to the respective members via GUI 826 of their respective PED (an example of which is shown in FIG. 11). For example, in the case where signage 904 is a QR code, the QR code may be linked to restaurant management software system 802, and as soon as any member of the group scans the QR code, GPT service 208 may know to link the PED accordingly. Then, any photograph submitted to GPT service 208 either by that same PED or by another PED of the group determined to be in the same proximity, will be easily integrated with restaurant management software system 802, such as shown in and described in connection with FIG. 8. Integration between restaurant management software system 802 and GPT computing system 106 may also include comparing, via comparison module 514 (shown in FIGS. 5 and 6), a total amount 612 (shown in FIG. 6, as well as individualized contributions 614A, 614B, 614C), to ensure the amounts to be charged are accurate.

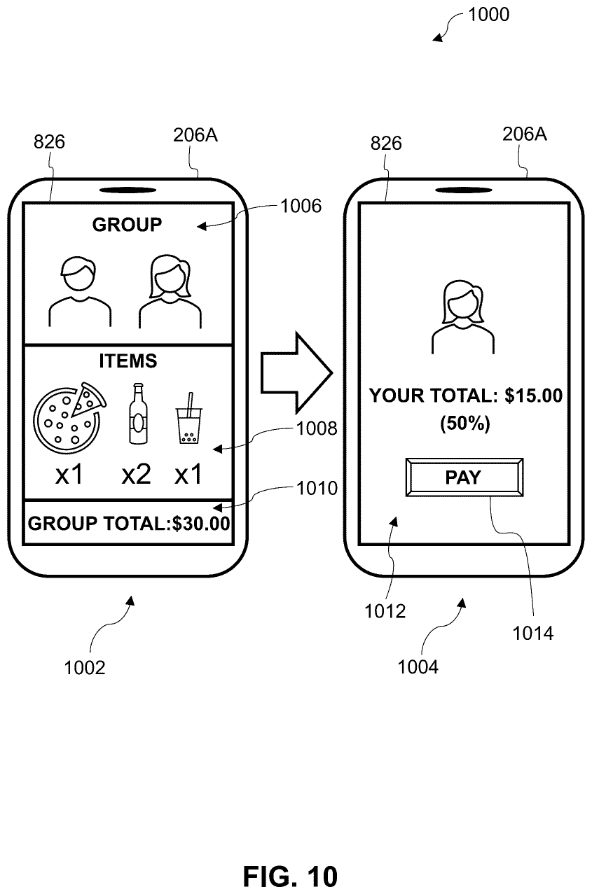

FIGS. 10 and 11 illustrate two different embodiments of how GPT service 208 may present splitting of the transaction amount of the group via GUI 826. FIG. 10 illustrates an embodiment where group members (e.g., 204A, 204B) agree to split the bill evenly (e.g., regardless of how much each person consumed individually), whereas FIG. 11 illustrates an embodiment where GPT service 208 permits the user to apportion the bill according to each individual group members individual consumption.

FIG. 10 illustrates an exemplary interface 1000 of GPT service 208, including a pre-payment interface 1002 and a payment interface 1004. Pre-payment interface 1002 includes: (i) a top pane 1006 showing the members of the group (e.g., 202), which may include a profile picture of each member as registered with GPT service 208; (ii) a middle pane 1008 showing the type and amount of items ordered (e.g., one pizza, two beers, one drink); and (iii) a bottom pane 1010 showing a total amount needing to be paid (e.g., group total). Pre-payment interface 1002 may transition to payment interface 1004 via clicking of a “Next” button or the like (not shown) within one of panes 1006, 1008, 1010 of pre-payment interface 1002. Payment interface 1004 includes a pane 1012 displaying the group member matching the particular PED (e.g., cardholder 204A for PED 206A), their individual amount due from the total amount, and a payment link 1014 (which may be configured as a clickable button within GUI 826). A payment amount displayed in pane 1012 in association with payment link 1014 for the particular group member may show the dollar amount due for the particular member, as well as a percentage of the total amount apportioned to the group member. For example, if the group only includes two members, the amount due may vary in dollars, but will always show 50% of the overall total amount. When payment link 1014 is clicked, the user's account (e.g., cardholder account 212A as shown in and described in connection with FIG. 6) is deducted the amount shown on PED 206A. The order of the panes as shown in FIG. 10 is not limiting, and the panes may appear in any order and/or proportion with the display area of a PED via GUI 826, and may be combined, further separated, etc.

FIG. 11 illustrates an exemplary alternative interface 1100 of GPT service 208, including a pre-payment interface 1102 and a payment interface 1104. Pre-payment interface 1102 includes: (i) a top pane 1106 showing a total amount needing to be paid (e.g., group total); (ii) a top middle plane 1108 showing one or more members of the group (e.g., 202), which may include a profile picture of each member as registered with GPT service 208; (iii) a bottom middle pane 1110 showing the type and amount of items ordered (e.g., one pizza, two beers, one drink); and (iv) a bottom pane 1112 showing other one or more members of the group. Pre-payment interface 1102 is configured to allow a user to use an input method 1114 (e.g., touch screen) of a PED to apportion items to various group members, such as via a drag-and-drop control to drag items from bottom middle pane 1110 and drop them in the appropriate pane(s) (e.g., 1108, 1112) of the group member that consumed the particular item(s). For example, in the context of FIG. 9 where the group members shared a pizza, a user is able to drag a graphical representation 1116 of the particular items (e.g., a slice of pizza, a beverage) from pane 1110 to the appropriate member pane (e.g., 1108, 1112) to match that the item(s) to the proper group member (graphical representation 1116 is shown in FIG. 11 as faded to indicate the drag-and-drop transition). Pre-payment interface 1102 may transition to payment interface 1104 via clicking of a “Next” button or the like (not shown) within one of panes 1106, 1108, 1110, 1112 of pre-payment interface 1102. Payment interface 1104 may include a primary pane 1118 displaying the group member matching the particular PED (e.g., cardholder 204A for PED 206A), their individual amount due from the total amount, and a payment link 1120 (which may be configured as a clickable button within GUI 826). Primary pane 1118 may also include a tally field 1122 showing the amount consumed of any particular item, which may be an editable field so as to adjust item counts as need be. Secondary pane 1124 may show apportionment information of one or more other members of the group. For example, secondary pane 1124 may show all other members of the group and their corresponding item tallies and amount due, any one member of the group (e.g., the member that ordered and/or owes the most), or allow a user to flip through each member one by one (e.g., by swiping right and/or left on a touch screen of the PED within pane 1124). Pane 1124 may also be configured to depict paid vs. unpaid users in a visual manner so that each member of the group can see who has/has not paid, or likewise for members that have not selected their particular items and dragged them to their pane. For example, an unpaid member may appear in gray, whereas a paid member may appear in color. As such, group members are able to see if their fellow group members have not selected their items and/or paid for their portion. This will prevent people from missing their items and/or leaving early. Compared to FIG. 10, the payment interface 1104 of FIG. 11 for the particular group member may show the dollar amount, as well as a percentage of the total apportioned to the group member, but each may vary depending on which member consumed which items. As shown in the example of FIG. 11, for a two member group, the member in the primary pane 1118 ate 3 slices of pizza and drank 1 drink, amounting to $10 of the $30 group total (or 33%). When payment link 1120 is clicked, the user's account (e.g., cardholder account 212A as shown in and described in connection with FIG. 6) is deducted the amount shown on PED 206A. The order of the panes as shown in FIG. 11 is not limiting, and the panes may appear in any order and/or proportion with the display area of a PED via GUI 826, and may be combined, further separated, etc. The embodiment in FIG. 11 also allows for one group member to easily cover another group members' portion of the bill, for example by dragging and dropping the items of the other member to the member covering their bill portion. Dragging and dropping is just one input method that may be used. The user interface 826 may be configured with sliders or other similar graphical objects to allow a user to manipulate the items and/or members shown onscreen to apportion the item and/or amount(s) to be paid in the desired ratio.

In another embodiment, other forms of input methods beyond input method 1114 may additionally or alternatively be used, including a gesture made by the user via a camera (e.g., front facing camera of the PED), where such gesture has been linked to a particular action within GPT application 402 and GPT service 208. For example, a gesture may include a motion mechanism for payment may be set by a user, including a wink (such as wink 720 show in FIG. 7) and/or a thumbs up (such as thumbs up 722 shown in FIG. 7), as well as a blink, smile, etc. In a live photograph mode of GPT application 402, GPT application 402 may capture the gesture and automatically withdraw the total amount due equally across the people in the photo (similar to the embodiment shown in and described in connection with FIG. 10, where the members of the group decide to evenly split the bill regardless of who ordered and consumed what). In such a case the gesture may be referred to as a live gesture. The motion mechanism may be prompted or confirmed by a visual cue, such as a quick flash pulse or, if in selfie mode, a graphic indicting payment requested or received.

In the embodiments shown in and described in connection with FIGS. 10 and 11, a message or other prompt may be pushed to each registered member via their phone number (e.g., text message), email (e.g., including a payment link), or mobile app (e.g., GPT application 402), so that they can view or participate in the process of splitting the bill, and select their own payment link (e.g., 1014, 1120) on their own PED for payment of their portion of the bill. For example, a first registered user such as cardholder 204A may initiate a group payment transaction session via the GPT service 208 using a first personal electronic device such as PED 206A, and a second registered user such as cardholder 204B joins the group payment transaction session using a second personal electronic device such as PED 206B. Cardholder 204B may join the group payment transaction session by: (i) accepting an invitation message sent from the GPT service 208; (ii) opening a GPT application (e.g., 402) associated with the GPT service 208 to join a session containing the group payment transaction; and (iii) transmitting credentials to PED 206A over a cellular, internet, or near-field communications protocol (where such credentials may include an IMEI device number, a response to a authentication request (e.g., a code used in conjunction with two-factor authentication, and the like)). These are merely a few examples on how other users may join or participate in the group payment transaction process of GPT service 208. Additionally, or alternatively, when a photograph such as photograph 702, 902 is taken, and the members of the group are identified, GPT computing system 106 may identify and link back to phone contacts, sending a payment link for amount due to each person in the photograph. Clicking of the payment link (e.g., 1014, 1120) may trigger the payment process shown in and described in connection with FIGS. 1 and 2 and as otherwise described herein (e.g., in connection with ISO 8583 messages), where each payment link click and corresponding payment may trigger its own authorization message to network 104. The payment link 1014, 1120 may be referred to as a payment submission option or payment request.

In some embodiments, the items may be provided in other formats such as a list format, and each member of the party may, via their own mobile device and/or a single mobile device, select only the items from the list that are attributable to them for payment purposes (or to pick up items for other members, if they so choose). The list format may list images of the items, a text description of the items, or a combination of both text and images. Each item may include a checkbox next to it for selection, or the user may be able to click the item itself and the item will be selected. In some aspects, the text and/or images may be imported via text and/or images provided by the merchant. For example, in the case of a restaurant, if the GPT processing system is integrated with the restaurant management system, the GPT processing system may pull the item information from the restaurant management system to populate the item information for display on the payment interface so that there is 1:1 correlation with the restaurant's system, for example as shown in FIG. 8.

In some embodiments, instead of or in addition to using photographs to determine members of the group and the items they ordered/purchased, audio may be utilized. For example, the GPT application may be able to utilize microphone hardware present on mobile devices (e.g., smart phones) of the group members to capture voice excerpts during the ordering of items. CV/ML module 318 may be configured to parse the audio and determine which member order which items based on voice. This may include storing voice files and/or voice profiles of registered users of within the GPT system so that audible orders can be processed for extracting items ordered by each user.

In some embodiments, the default payment interface may apportion a bill evenly amongst the amount of group members (e.g., 33% for each person of a three-member group). The members may pay according to the default setting, or override the default setting to instead apportion the bill in a desired ratio.

FIG. 12 is a schematic diagram illustrating an exemplary scheme for building, training, and implementing computer vision (CV) and machine learning (ML) models according to one embodiment of the present disclosure. GPT computing system 106 (shown in FIGS. 1 and 2) may communicate with other components of system 100 (and system 200) (shown in FIG. 1/2) via network 306 (shown in FIG. 3), such as in the manner shown in FIGS. 1 and 2. Storage device 320 (shown in FIG. 3) may be connected to network 306 and store data 1202 including object detection data and biometric data, such as in connection with object detection module 606 and biometric module 608 (each shown in FIG. 6) of CV/ML module 318 (shown in FIG. 3). Data 1204 received from network 306 may be stored in storage device 320, where storage device 320 may include one or more databases. GPT computing system 106 may be configured to use data 1204 to generate an object detection model 1206 and a biometric model 1208 for use with GPT service 208 and within GPT computing system 106 in identifying and authenticating individuals, and splitting and processing payments, and the like, as described herein.

In exemplary embodiments, GPT computing system 106 includes a training set builder module 1210 for object detection model 1206 and training set builder module 1212 for biometric model 1208, where training set builder module 1210 is configured to submit one or more queries 1214 to a database of or associated with storage device 320 to retrieve subsets 1216 of data 1204, and to use those subsets 1216 to build training data sets 1218 for generating the objection detection model 1206. For example, query 1214 may be configured to retrieve certain fields from data 1202, such as object detection data used in connection with computer vision object detection, and the like. Training set builder module 1212 for biometric model 1208 is configured to submit one or more queries 1220 to a database of or associated with storage device 320 to retrieve subsets 1222 of data 1204, and to use those subsets 1222 to build training data sets 1224 for generating the biometric model 1208. For example, query 1220 may be configured to retrieve certain fields from data 1202, such as biometric data (e.g., biometric templates for facial detection) used in connection with computer vision person detection, and the like. Due to the parallel nature of the building, training, and implementing of models 1206 and 1208, the various modules and outputs of such are described in tandem below.

In exemplary embodiments, training set builder modules 1210/1212 may be configured to derive respective training data sets 1218/1224 from respective retrieved subsets 1216/1222, respectively. Each training data set 1218/1224 corresponds to the applicable data 1204 (e.g., “historical” data, which in this context means object detection and biometric data of the past, as opposed to real-time with respect to the time of retrieval by training set builder modules 1210/1212). Each training data set 1218/1224 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 1218/1224 may be generated from data fields in subsets 1216/1222 corresponding to (e.g., historical) data 1204. In other words, a trained machine learning model 1226/1228 produced by a respective model trainer module 1230/1232 for use by objection detection model 1206 and biometric model 1208 is/are trained to make predictions based on input values that can be generated from the data fields in data 1204. Values in the model input data fields may include values copied directly from values in a corresponding data field in the retrieved subsets 1216/1222, and/or values generated by modifying, combining, or otherwise operating upon values in one or more data fields in the retrieved subsets 1216/1222. The use of such data fields as model input data fields facilitates the machine learning model in weighing these factors directly.

After training set builder module 1210/1212 generates training data sets 1218/1224, training set builder module 1210/1212 passes the training data sets 1218/1224 to model trainer modules 1230/1232. In example embodiments, model trainer modules 1230/1232 is/are configured to apply the model input data fields of each training data set 1218/1224 as inputs to one or more machine learning models. Each of the one or more machine learning models is programmed to produce, for each training data set 1218/1224, at least one output intended to correspond to, or “predict,” a value of the at least one result data field of the training data set 1218/1224. “Machine learning” refers broadly to various algorithms that may be used to train the model to identify and recognize patterns in existing data in order to facilitate making predictions for subsequent new input data.

Model trainer modules 1230/1232 is/are configured to compare, for each training data set 1218/1224, the at least one output of the model to the at least one result data field of the training data set 1218/1224, and apply a machine learning algorithm to adjust parameters of the model in order to reduce the difference or “error” between the at least one output and the corresponding at least one result data field. In this way, model trainer modules 1230/1232 train the machine learning model to accurately predict the value of the at least one result data field. In other words, model trainer modules 1230/1232 cycles the one or more machine learning models through the training data sets 1218/1224, causing adjustments in the model parameters, until the error between the at least one output and the at least one result data field falls below a suitable threshold, and then uploads trained machine learning models 1226/1228 to objection detection model 1206 and biometric model 1208, respectively, for application to generating recommendations 1234/1236. In exemplary embodiments, model trainer module 1230/1232 may be configured to simultaneously train multiple candidate machine learning models and to select the best performing candidate for each result data field, as measured by the “error” between the at least one output and the corresponding result data field, to upload to objective detection module 1206 and biometric model 1208.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer modules 1230/1232 cycle through the training data sets 1218/1224, model trainer modules 1230/1232 apply a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer modules 1230/1232 provide an advantage by automatically discovering and properly weighting complex, second-or third-order, and/or otherwise nonlinear interconnections between the model input data fields and the at least one output. Absent the machine learning model, such connections are unexpected and/or undiscoverable by human analysts.

The GPT computing system 106 of the present disclosure is configured to operate on input data related to objects and body features from photographs, as well as restaurant data such as tables, item names, prices, and determine matches of object, biometric, and restaurant data. In one exemplary embodiment, the GPT computing system 106 executes each of the object detection model 1206 and the biometric model 1208 programmed to learn, without limitation, the appearances of humans and objects (e.g., food, beverages) based upon varying photographed environments, the queries used to prompt a user to provide relevant information, features of objects and humans related to purchases, and the like.

To facilitate this learning, the GPT computing system 106 includes one or more databases of or associated within storage device 320 at which the data, including requests, responses, feature codes, evidence, outcomes, etc., is stored. This data becomes one or more input training sets used by the training set builders 1210/1212. Model outputs can be formatted for presentation or review as visual representations of recommendations, as text-based or natural language recommendations, and the like. In exemplary embodiments, objection detection model 1206 and biometric model 1208 may compare respective feedback, and may route a respective comparison result 1238/1240 generated by comparing recommendations 1234/1236 to the feedback to a respective model updater module 1242/1244 of the GPT computing system 106. Model updater modules 1242/1244 is/are configured to derive a respective correction signal 1246/1248 from comparison results 1238/1240 received for one or more recommendations and to provide correction signal 1246/1248 to model trainer module 1230/1232 to enable updating or “re-training” of the at least one machine learning model to improve performance. The retrained at least one machine learning model 1226/1228 may be respectively and periodically re-uploaded to objection detection model 1206 and biometric model 1208.

Outputs 1250/1252 from objection detection model 1206 and biometric model 1208 may be utilized by and with GPT service 208 to provide GPT service 208 the ability to detect objects and people from photographs for purposes of registering users for GPT service 208 and splitting bills amongst the users as described herein. Moreover, models 1206 and 1208 can be used, along with other user information from network 104, merchants 108, and any other entity within system 100, to build a user identification profile for registered users, where such user identification profiles may include various photographs (e.g., from different angles, with different hair style, facial hair, etc.) of each user, and other related information as described herein, such as gestures that a user has selected to trigger payment.

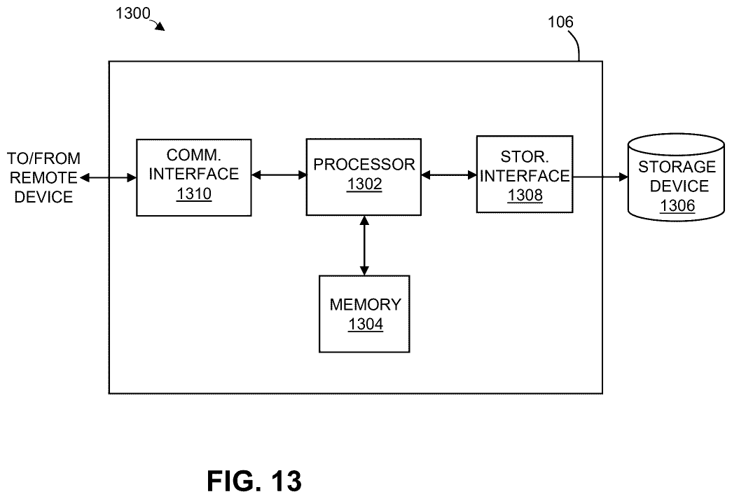

FIG. 13 illustrates an example configuration 1300 of GPT computing system 106 in accordance with one example embodiment of the present disclosure. Configuration 1300 of GPT computing system 106 may include a processor 1302 operatively coupled with a memory 1304. In some embodiments, GPT computing system 106 may include one or more additional processors 1302 operatively coupled with one or more additional memories 1304, where the processors and memories may be operatively coupled with one another, and may be configured to provide parallel computing functions (e.g., to assist with resource heavy computing tasks). Additional processors and additional memories may be integrated with GPT computing system 106, or may be integrated with one or more other (e.g., external) computing systems such as distributed computing systems (not shown) that is/are operatively coupled with GPT computing system 106. Configuration 1300 of GPT computing system 106 may also include a storage device 1306 configured to store data, and be accessible via storage interface 1308. While storage device 1306 is shown in FIG. 13 as being external to GPT computing system 106, storage device 1306 may be integrated with GPT computing system 106. Storage device 1306 may be embodied as storage device 320 shown in FIG. 3 (or vice versa, where storage device 320 may have a storage interface that is the same as or similar to storage interface 1308)), or other storage devices within system 200. GPT computing system 106 may communicate (e.g., via network 306) with other devices (e.g., remote devices) within system 200 as shown in FIG. 2 via a communication interface 1310.

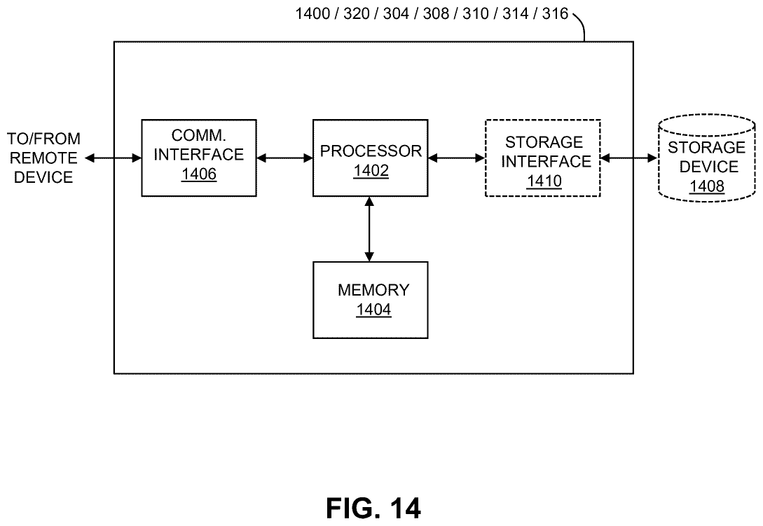

FIG. 14 illustrates an example configuration of a database such as a database 1400 of storage device 320 (shown in FIG. 3), and/or various client computing devices such as client devices (e.g., 302, 304) and/or server devices (e.g., 308, 310, 314, 316) in accordance with one embodiment of the present disclosure. Devices 1400, 302, 304, 308, 310, 314, 316 each include a processor 1402 operatively coupled with a memory 1404. The various devices (e.g., 1400, 302, 304, 308, 310, 314, 316) may communicate with other devices (e.g., remote devices) within system 200 shown in FIG. 2 via a communication interface 1406 operatively coupled to processor 1402. In some embodiments, processor 1402 is operatively coupled to storage device 1408 via a storage interface 1410, to access or store data within storage device 1408. Storage device 1408 may be standalone storage or embodied as any storage device (e.g., 320) within system 200 as described herein.

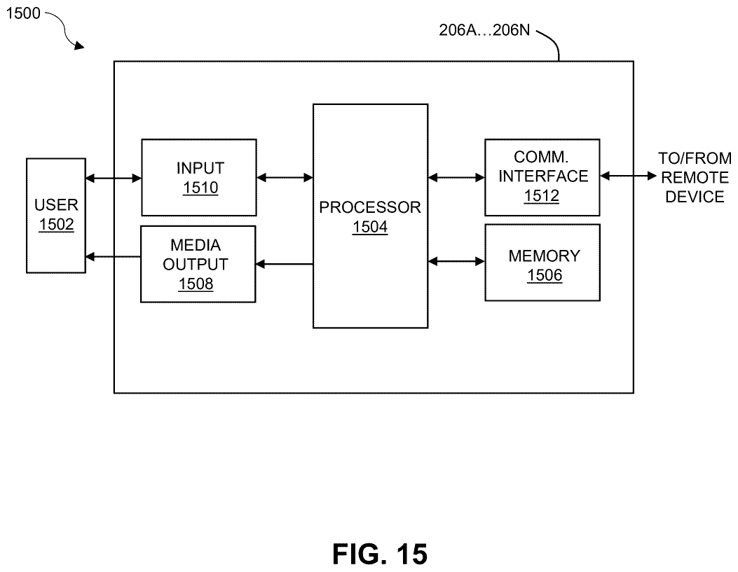

FIG. 15 illustrates an example configuration 1500 of a PED (e.g., 206A . . . 206N) used in conjunction with GPT computing system 106 within system 200, so that a user 1502 (e.g., 204A . . . 204N) may utilize GPT service 208. Each PED (e.g., 206A . . . 206N) includes a processor 1504 operatively coupled with a memory 1506. Each PED (e.g., 206A . . . 206N) also includes at least one media output component 1508 for presenting information to user 1502. In some embodiments, media output component 1508 includes an output adapter such as a video adapter and/or an audio adapter. An output adapter is operatively coupled to processor 1504 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, each PED (e.g., 206A . . . 206N) includes an input device 1510 for receiving input from user 1502. Input device 1510 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 1508 and input device 1510. Each PED (e.g., 206A . . . 206N) further includes a communication interface 1512 so that each PED (e.g., 206A . . . 206N) may communicate with other computing devices (e.g., remote devices) within system 200 shown in FIG. 2.

Each of the processors (e.g., 1302, 1402, 1504) described in connection with FIGS. 13-15 may be configured to execute instructions that may be stored in the corresponding memories (e.g., 1304, 1404, 1506) shown in and described in connection with FIGS. 13-15, for example. The processors may include one or more processing units (e.g., in a multi-core configuration) for executing instructions, and may be configured to operate in a parallel processing environment as described herein. The instructions may be executed within a variety of different operating systems on the respective systems, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.). The memories may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Each of the storage devices (e.g., 1306, 1408) shown in and described in connection with FIGS. 13 and 14 may include one or more computer-readable media, such as one or more hard disk drives or solid state disks in a redundant array of inexpensive disks (RAID) configuration, and further may include a storage area network (SAN) and/or a network attached storage (NAS) system. Each of the storage interfaces (e.g., 1308, 1410) shown in and described in connection with FIGS. 13 and 14 may be any component capable of providing the processors with access to the storage devices. Storage interfaces may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processors with access to the storage devices.

Each of the various communication interfaces (e.g., 1310, 1406, 1512) shown in and described in connection with FIGS. 13-15 may be communicatively couplable to a remote device such as a server system (e.g., 308, 310, 314, 316) or a web server, and may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)). For example, communication interface 1310 may receive data from payment network server 308 and/or issuer system 304 via the Internet, as illustrated in FIG. 3. The various databases (e.g., 520, 1400) may be configured as object-oriented databases, relational databases such as but not limited to SQL databases, and the like.

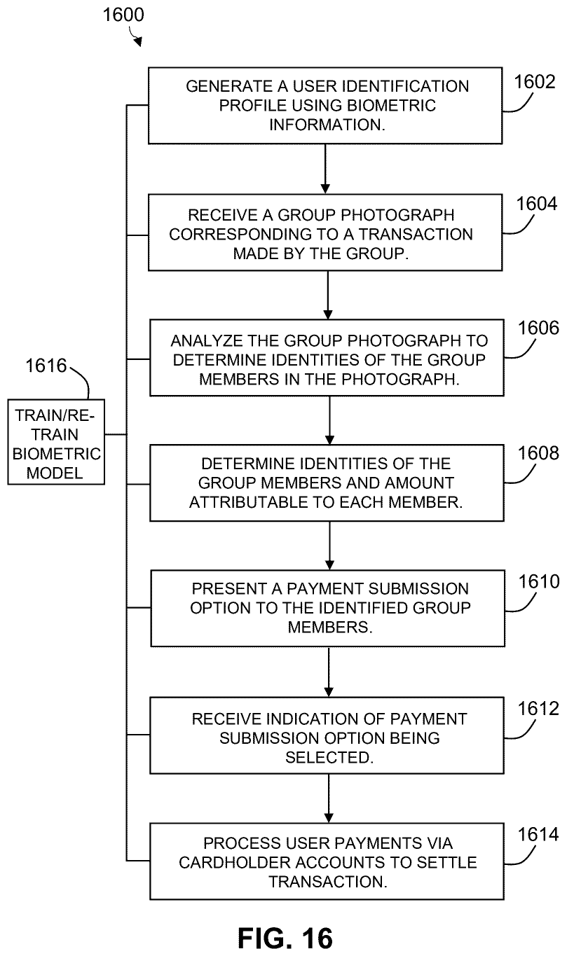

FIG. 16 illustrates an example process flow 1600 for detection and identification of users of GPT service 208 via biometrics and payments made via GPT service 208 in accordance with one embodiment of the present disclosure. Step 1602 includes generating a user identification profile (e.g., 544) using biometric information. This may include, for example, aspects shown in and described in connection with FIG. 5B. Step 1604 includes receiving a group photograph (e.g., 702, 902) corresponding to a transaction made by a group (e.g., 202), such as shown in and described in connection with FIGS. 6-9. Step 1606 includes analyzing the group photograph to determine identities of group members included in the photograph, such as shown in and described in connection with FIGS. 6-9. Step 1608 includes determining the identities of the group members and an amount of the transaction attributable to each member, such as shown in and described in connection with FIGS. 5B and 6-9. Step 1610 includes presenting a payment submission option (e.g., 1014, 1120) to the identified group members, such as shown in and described in connection with FIGS. 10 and 11. Step 1612 includes receiving an indication of the payment submission option being selected, such as shown in and described in connection with FIGS. 1-3, 10, and 11. Step 1614 includes processing user payments via cardholder accounts of the members to settle the transaction, such as shown in and described in connection with FIGS. 1-3, 6, 10, and 11. Step 1616 includes training/re-training the biometric model based on the performance of the other steps 1602 to 1614, such as shown in and described in connection with FIG. 12.

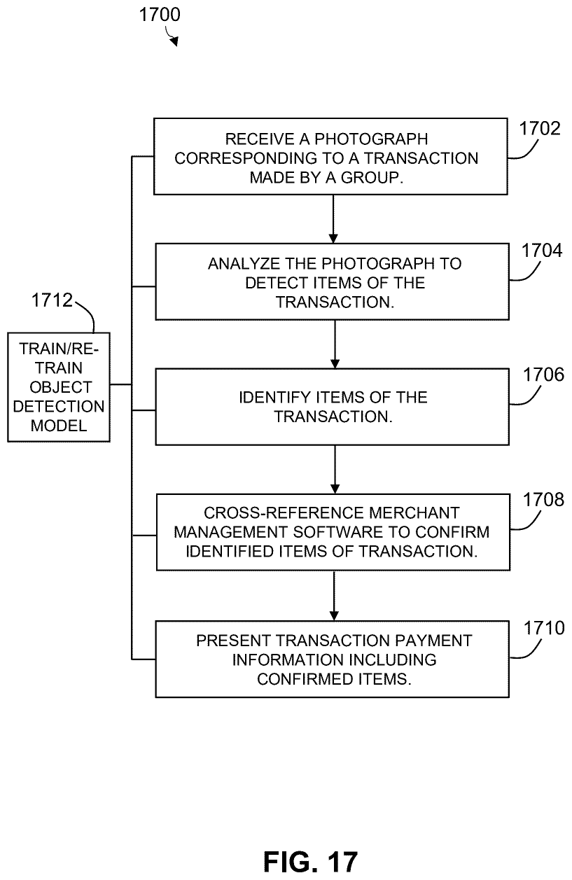

FIG. 17 illustrates an example process flow 1700 for detecting objects in accordance with one embodiment of the present disclosure. Step 1702 includes receiving a photograph (e.g., 702, 902) corresponding to a transaction made by a group (e.g., 202) of people, such as shown in and described in connection with FIGS. 6-9. Step 1704 including analyzing the photograph to detect and determine items (e.g., 610A to 610N, 714, 808) included in the transaction, such as shown in and described in connection with FIGS. 6-9. Step 1706 includes identifying items included in the transaction, such as shown in and described in connection with FIGS. 6-9. Step 1708 includes cross-referencing merchant management software (e.g., 322, 802) to confirm identified items included in the transaction, such as shown in and described in connection with FIGS. 3 and 8. Step 1710 includes presenting transaction payment information (e.g., 1014, 1120) to a user including the confirmed items, such as shown in and described in connection with FIGS. 10 and 11. Step 1712 includes training/re-training an object model based on the performance of the other steps 1702 to 1710, such as shown in and described in connection with FIG. 12.

While the examples herein as presented relative to dividing a food bill in a restaurant setting, the GPT computing system 106 may be used in any scenario where items are purchased by a group of people and the bill is to be split. For example, members of a book club may buy one or more books from a book store, and may apportion each book(s) to the members. The example scenarios described herein are but a few applications of GPT system 106, and are not limiting.

The term “processor”, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor and can be implemented in a high-level procedural and/or object-oriented programming language, and/or in assembly/machine language. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium and computer-readable medium do not include transitory signals.

The above-described embodiments of a method and system of computing velocities in an efficient manner within a distributed computing systems framework provides a cost-effective and time-saving means for analyzing a high volume of transaction data in payment network platforms. As a result, the methods and systems described herein facilitate leveraging a payment network's assets to improve analysis of data contained within the network, to thereby improve the quality of data within the network.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A group payment computing system comprising:
a group payment computing device including one or more processors in communication with one or more memory devices, the one or more processors programmed to:
receive a group transaction image associated with a transaction including one or more members of a group for purposes of dividing, amongst the one or more members of the group, a transaction amount associated with the transaction made by the group at a merchant, the group transaction image being a photographic image showing a portion of the one or more members of the group;
analyze the group transaction image using computer vision tools to determine an identity of the one or more members of the group associated with the transaction;
determine an amount of the transaction attributable to each of the one or more members of the group associated with the transaction based upon input from the one or more members of the group;
cause a payment submission option to be displayed on a user device associated with the one or more members of the group, the payment submission option corresponding to the amount of the transaction attributable to each of the one or more members of the group associated with the transaction; and
in response to the payment submission option being selected, initiate a plurality of payment transactions, each payment transaction being between one of the one or more members of the group and the merchant for the attributable amount for the respective member of the one or more members of the group.

2. The group payment computing system in accordance with claim 1, wherein the merchant is a restaurant, the restaurant uses restaurant management software to manage operations of the restaurant, the transaction reflects at least one item sold by the restaurant to the group as part of the transaction, and the one or more processors are further programmed to access the restaurant management software to assist in determining an amount, type, and price of the at least one item sold by the restaurant to the group as part of the transaction.

3. The group payment computing system in accordance with claim 1, wherein the one or more processors are further programmed to:
receive identifying information for each of one or more members of the group;
build one or more user identification profiles based on the identifying information; and
register (i) at least one of the one or more members of the group as a registered user using a corresponding user identification profile of the one or more user identification profiles, and/or (ii) the user device.

4. The group payment computing system in accordance with claim 3, wherein the registered user is a first registered user and a second registered user, the user device is a first personal electronic device of the first registered user and a second personal electronic device of the second registered user, the first registered user initiates a group payment session using the first personal electronic device and the second registered user joins the group payment session using the second personal electronic device, wherein the second registered user joins the group payment session by performing at least one of: (i) accepting an invitation message via the second personal electronic device;
(ii) using a group payment application to join the group payment session, the group payment application being accessible on the second personal electronic device; and
(iii) transmitting, via the second personal electronic device, credentials to the first personal electronic device over a cellular, internet, or near-field communications protocol.

5. The group payment computing system in accordance with claim 3, wherein the portion is a head, the identifying information includes one or more facial recognition datapoints of the one or more members of the group, and the computer vision tools are configured to determine an identity match between the at least one of the one or more members of the group present in the photographic image and a user identification profile of the registered user.

6. The group payment computing system in accordance with claim 5, wherein the photographic image shows at least one item sold by the merchant to the group as part of the transaction, and the computer vision tools are configured to detect the at least one item.

7. The group payment computing system in accordance with claim 3, wherein the identifying information is at least in part based on data from personal contacts stored in the user device, the user device being a registered device.

8. The group payment computing system in accordance with claim 7, wherein the identifying information further includes geo-location data of the group, and the geo-location data is associated with the user device.

9. The group payment computing system in accordance with claim 8, wherein the group further includes one or more non-registered users, the identifying information further includes data from a government database, and the data from the government database is used to authenticate the one or more non-registered users for presenting and processing the payment submission option associated with at least one non-registered user of the one or more non-registered users.

10. A computer-implemented method for providing a group payment computing system using at least one processor in communication with at least one memory, the method comprising:
receiving a group transaction image associated with a transaction including one or more members of a group for purposes of dividing, amongst the one or more members of the group, a transaction amount associated with the transaction made by the group at a merchant, the group transaction image being a photographic image showing a portion of the one or more members of the group;
analyzing the group transaction image using computer vision tools to determine an identity of the one or more members of the group associated with the transaction;
determining an amount of the transaction attributable to each of the one or more members of the group associated with the transaction based upon input from the one or more members of the group;
causing a payment submission option to be displayed on a user device associated with the one or more members of the group, the payment submission option corresponding to the amount of the transaction attributable to each of the one or more members of the group associated with the transaction; and
in response to the payment submission option being selected, initiating a plurality of payment transactions, each payment transaction being between one of the one or more members of the group and the merchant for the attributable amount for the respective member of the one or more members of the group.

11. The method in accordance with claim 10, wherein the merchant is a restaurant, the restaurant uses restaurant management software to manage operations of the restaurant, and the transaction reflects at least one item sold by the restaurant to the group as part of the transaction, the method further comprising accessing the restaurant management software to assist in determining an amount, type, and price of the at least one item sold by the restaurant to the group as part of the transaction.

12. The method in accordance with claim 10, further comprising:
receiving identifying information for each of one or more members of the group;
building one or more user identification profiles based on the identifying information; and
registering (i) at least one of the one or more members of the group as a registered user using a corresponding user identification profile of the one or more user identification profiles, and/or (ii) the user device.

13. The method in accordance with claim 12, wherein the portion is a head, and the identifying information includes one or more facial recognition datapoints of the one or more members of the group, the method further comprising:
determining, via the computer vision tools, an identity match between the at least one of the one or more members of the group present in the photographic image and a user identification profile of the registered user.

14. The method in accordance with claim 12, wherein the identifying information is at least in part based on: (i) data from personal contacts stored in the user device, the user device being a registered device; and (ii) geo-location data of the group, the geo-location data being associated with the user device.

15. The method in accordance with claim 12, wherein the group further includes one or more non-registered users, and the identifying information further includes data from a government database, the method further comprising:
authenticating, via the data from the government database, the one or more non-registered users for presenting and processing the payment submission option associated with at least one non-registered user of the one or more non-registered users.

16. One or more non-transitory computer-readable storage media with instructions stored thereon that, in response to being executed, cause a group payment computing system to:
receive a group transaction image associated with a transaction including one or more members of a group for purposes of dividing, amongst the one or more members of the group, a transaction amount associated with the transaction made by the group at a merchant, the group transaction image being a photographic image showing a portion of the one or more members of the group;
analyze the group transaction image using computer vision tools to determine an identity of the one or more members of the group associated with the transaction;
determine an amount of the transaction attributable to each of the one or more members of the group associated with the transaction based upon input from the one or more members of the group;
cause a payment submission option to be displayed on a user device associated with the one or more members of the group, the payment submission option corresponding to the amount of the transaction attributable to each of the one or more members of the group associated with the transaction; and
in response to the payment submission option being selected, initiate a plurality of payment transactions, each payment transaction being between one of the one or more members of the group and the merchant for the attributable amount for the respective member of the one or more members of the group.

17. One or more non-transitory computer-readable storage media in accordance with claim 16, wherein the merchant is a restaurant, the restaurant uses restaurant management software to manage operations of the restaurant, the transaction reflects at least one item sold by the restaurant to the group as part of the transaction, and the one or more processors are further programmed to access the restaurant management software to assist in determining an amount, type, and price of the at least one item sold by the restaurant to the group as part of the transaction.

18. One or more non-transitory computer-readable storage media in accordance with claim 16, wherein the one or more processors are further programmed to:
receive identifying information for each of one or more members of the group;
build one or more user identification profiles based on the identifying information; and
register (i) at least one of the one or more members of the group as a registered user using a corresponding user identification profile of the one or more user identification profiles, and/or (ii) the user device.

19. One or more non-transitory computer-readable storage media in accordance with claim 16, wherein the portion is a head, the identifying information includes one or more facial recognition datapoints of the one or more members of the group, and the computer vision tools are configured to determine an identity match between the at least one of the one or more members of the group present in the photographic image and a user identification profile of the registered user.

20. One or more non-transitory computer-readable storage media in accordance with claim 19, wherein the identifying information is at least in part based on: (i) data from personal contacts stored in the user device, the user device being a registered device; and (ii) geo-location data of the group, the geo-location data being associated with the user device.
